(19) United States
(12) Patent Application Publication
(10) Pub. No.: US 2024/0152887 A1
(43) Pub. Date: May 9, 2024

(54) DIGITAL ASSET-BASED INTERACTION SYSTEM WITH ONE OR MORE STAKED DISTRIBUTED LEDGER TECHNOLOGY (DLT) NETWORKS

(71) Applicant: Flexa Inc., New York, NY (US)

(72) Inventors: Trevor Filter, New York, NY (US); Zachary Kilgore, Brooklyn, NY (US); Tyler Robert Spalding, New York, NY (US)

(73) Assignee: Flexa Inc., New York, NY (US)

(21) Appl. No.: 18/502,152

(22) Filed: Nov. 6, 2023

Related U.S. Application Data
(60) Provisional application No. 63/382,706, filed on Nov. 7, 2022.

(51) Int. Cl. G06Q 20/10; G06Q 20/40

(52) U.S. Cl. CPC G06Q 20/10; G06Q 20/4016

(57) ABSTRACT

A method includes obtaining, by a digital asset-based interaction computing entity, digital asset-based interaction information. The digital asset-based interaction involves a source computing entity providing a first amount of digital assets and a destination computing entity accepting a second amount of desired assets. The method further includes performing a real-time digital asset-based interaction process to facilitate the digital asset-based interaction in real-time and performing a nonreal-time digital asset-based interaction process to reconcile the real-time digital asset-based interaction process with a digital asset backing computing entity. The digital asset backing computing entity is associated with a transformer pool of the digital asset-based interaction system. The transformer pool is associated with one or more consensus network computing entity nodes of a digital asset distributed ledger technology (DLT) network associated with the digital assets. The transformer pool stores system digital assets to back digital asset-based interactions involving the digital assets.

### CROSS-REFERENCE TO RELATED APPLICATIONS

The present U.S. Utility patent application claims priority pursuant to 35 U.S.C. § 119(e) to U.S. Provisional Application No. 63/382,706, entitled “DIGITAL ASSET-BASED INTERACTION SYSTEM WITH ONE OR MORE STAKED DISTRIBUTED LEDGER TECHNOLOGY (DLT) NETWORKS,” filed Nov. 7, 2022, which is hereby incorporated herein by reference in its entirety and made part of the present U.S. Utility patent application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This disclosure relates generally to a digital asset-based interaction system and more specifically to a digital asset-based interaction system where one or more digital asset distributed ledger technology (DLT) networks are staked to back digital asset-based interactions involving digital assets associated with the one or more digital asset DLT networks.

### Description of Related Art

Current payment systems are vulnerable to security breaches, fraud, and identity theft. A typical payment card transaction with a merchant involves several steps (e.g., payment card authorization, clearing, and settlement) and the participation of various entities (e.g., financial institutions, payment card companies, and payment processing networks). Each step and each entity have their own varying security limitations. The steps involved are also inconvenient, time consuming, and expensive. For example, payment card authorization (e.g., credit or debit card authorization) begins with the cardholder presenting the payment card to a merchant for goods or service.

The payment card is issued by a particular financial institution (e.g., a bank) and is associated with a payment card network (e.g., Visa, Mastercard, etc.). The merchant uses a payment card machine, software, or gateway to transmit transaction data to their acquiring bank (or its processor). The acquiring bank routes the transaction data to a payment processing network, and the payment processing network sends the transaction data to the cardholder's issuing bank. The issuing bank validates that the card has not been reported stolen or lost, confirms whether funds/credit is available, and sends a response code back through the payment processing network to the acquiring bank as to whether the transaction is approved.

The transaction data typically includes the payment card number, transaction amount, date, merchant's name, merchant's location, merchant category code, and an encrypted personal identification number (PIN) if entered. A response code reaches the merchant's terminal and is stored in a file until it is settled. The merchant sends the stored, approved transactions to its acquiring back (e.g., at the end of the day) and the acquiring bank reconciles and transmits approved transactions through the appropriate card-processing network. The acquiring bank deposits funds from sales into the merchant's account. The payment processing network debits the issuing bank account and credits the acquiring bank account for the amount of the transaction.

Merchants pay substantial payment card processing fees, and those costs are passed along to consumers in the form of higher prices. Most merchants pay an interchange rate on a total transaction and a flat fee to the payment card company involved (e.g., Visa, Mastercard, etc.). Rates vary based on the payment card company, the payment card type (e.g., credit, debit, business, etc.), processing type (e.g., online payment, swiped, through a mobile device, card not present, etc.), and a Merchant Category Code (MCC) that classifies a merchant's type of business. Further, merchants typically pay a commission and a flat fee to the payment processing network.

Traditional bank account-linked mobile wallet applications allow cardholders to store payment card data on a computing device via a digital wallet for more convenient transactions. For example, some mobile wallet apps use near field communication (NFC) for contactless payments (e.g., exchange of data by holding a device over a payment reader). NFC chips are specifically designed to manage financial security and only store data needed to initiate and complete a transaction. Mobile wallets use types of tokenization to assign a device account number (DAN) in place of an account or card number so that the DAN is passed to the merchant rather than the actual account/card number. As another security measure, digital wallets rely on digital certificates to verify identity. However, using a digital wallet on a device means data passes through not only the device's hardware and operating system but then also a specific payment app, and then finally the source of payment.

Digital assets are digitally stored content that comes with a right to use. As a few examples, digital assets include images, audio, videos, documents (e.g., contracts, legal documents, etc.), cryptocurrency, cryptocurrency tokens, stocks, and intellectual property rights. Distributed ledger technology (DLT) is a digital system that provides a consensus of replicated, shared, and synchronized digital data spread across several nodes. Unlike traditional databases, DLTs often lack central authority. The nodes of a DLT implement a verification process such as a consensus method to validate the authenticity of transactions recorded in the ledger.

Distributed ledger technology reduces the risk of fraudulent activity in creating and executing transactions (e.g., such as payments). For example, a blockchain is a type of DLT consisting of a continuously growing list of blocks (i.e., groups of transactions) that are securely linked, continually reconciled, and shared among all network participants (i.e., a decentralized network). Transactions are validated and added to blocks via hashing algorithms, and then permanently written to the chain via consensus of the network. Once recorded on the blockchain, transactions cannot be altered.

A cryptocurrency is a digital asset that is securely created and transferred via cryptography. Many cryptocurrencies exist on distributed networks based on DLT (e.g., a blockchain). Decentralized networks like Bitcoin use pseudo-anonymous transactions that are open and public (i.e., anyone can join, create, and view transactions). To eliminate fraudulent transactions and deter malicious network activity, cryptocurrency transactions can be recorded by “miners” using “proof of work” secure hashing algorithms (SHA-256) that require significant computing power. While many cryptocurrencies are blockchain based, other distributed ledger technologies may be used. For example, asynchronous consensus algorithms enable a network of nodes to communicate with each other and reach consensus in a decentralized manner. This method does not need miners to validate transactions and uses directed acyclic graphs for time-sequencing transactions without bundling them into blocks.

### BRIEF DESCRIPTION OF THE SEVERAL VIEWS OF THE DRAWING(S)

FIG. 1 is a schematic block diagram of an embodiment of a digital asset-based interaction system;

FIG. 2 is a schematic block diagram of another embodiment of a digital asset-based interaction system;

FIG. 3 is a schematic block diagram of another embodiment of a digital asset-based interaction system;

FIG. 3A is a schematic block diagram of an embodiment of a portion of the digital asset-based interaction system;

FIG. 4 is a flowchart of an example of a method of initiating a digital asset-based interaction;

FIG. 5 is a flowchart of an example of a method of a digital asset-based interaction computing entity facilitating a digital asset-based interaction;

FIG. 6 is a flowchart of an example of a method of a real-time digital asset-based interaction process;

FIG. 7 is a flowchart of an example of a method of a nonreal-time digital asset-based interaction process;

FIG. 8 is a flowchart of an example of a method of a real-time digital asset-based interaction process;

FIG. 9 is a flowchart of an example of a method of a real-time digital asset-based interaction process;

FIG. 10 is a flowchart of an example of a method of a real-time digital asset-based interaction process;

FIGS. 11A-11C are flowcharts of an example of a method of a nonreal-time digital asset-based interaction process;

FIG. 12 is a schematic block diagram of an embodiment of a portion of a digital asset-based interaction system;

FIG. 13 is a schematic block diagram of an embodiment of a portion of a digital asset-based interaction system;

FIG. 14 is a schematic block diagram of an embodiment of a portion of a digital asset-based interaction system;

FIG. 15 is a flowchart of an example of a method of distributing system digital assets as rewards;

FIG. 16 is schematic block diagram of an embodiment of a digital asset-based interaction system;

FIG. 17 is a schematic block diagram of an embodiment of a digital asset-based interaction computing entity;

FIG. 18 is a schematic block diagram of an example of system authorization parameters and digital asset-based interaction characteristics;

FIG. 19 is a schematic block diagram of an embodiment of a portion of a digital asset-based interaction system;

FIG. 20 is a schematic block diagram of an embodiment of a portion of a digital asset-based interaction system;

FIG. 21 is a schematic block diagram of an embodiment of a digital asset-based interaction computing entity;

FIG. 22 is a schematic block diagram of an embodiment of a digital asset-based interaction computing entity;

FIG. 23 is a schematic block diagram of an embodiment of a digital asset-based interaction computing entity; and

FIG. 24 is a flowchart of an example of a method of a digital asset-based interaction authorization process.

### DETAILED DESCRIPTION OF THE INVENTION

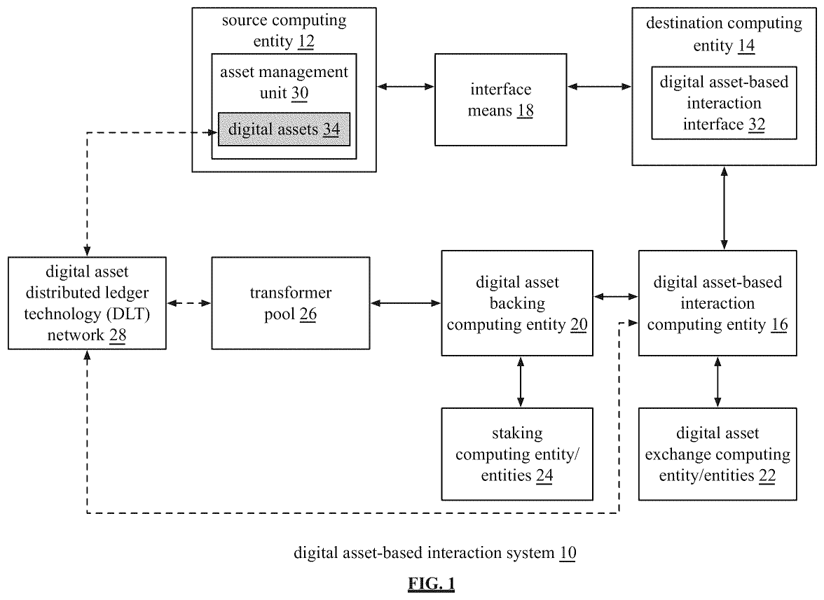

FIG. 1 is schematic block diagram of an embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, at least one transformer pool 26, and at least one digital asset distributed ledger technology (DLT) network 28.

The digital asset-based interaction system 10 facilitates digital asset-based interactions (e.g., a digital asset-based payment) between the source computing entity 12 and the destination computing entity 14. A digital asset-based interaction is any activity (e.g., a loan, a payment, etc.) involving the source computing entity 12 providing digital assets (e.g., digital assets 34) and the destination computing entity 14 accepting desired assets (e.g., fiat currency or a desired digital asset that differs from the digital asset the source computing entity 12 wishes to use in the digital asset-based interaction). Digital assets are digitally stored content that comes with a right to use. As a few examples, digital assets include images, audio, videos, documents (e.g., contracts, legal documents, etc.), cryptocurrency, cryptocurrency tokens, digital fiat currency, stocks, and intellectual property rights.

The digital asset-based interaction system 10 overcomes the following issues. At the filing of this application, digital assets such as cryptocurrency are not widely accepted by merchants as a form of payment for a variety of reasons. For one, many merchants do not want to hold digital assets. Holding digital assets involves several issues merchants are unfamiliar with and/or unequipped to deal with. These issues include holding private key information, legal compliance, government regulation, timing issues such as waiting for transaction confirmations, etc. Accepting digital assets such as cryptocurrency presents operational security issues and includes a level of technical complexity outside the scope of general merchant capabilities. Additionally, the value of digital assets can be volatile, sometimes fluctuating dramatically in the course of one day. As another reason, merchants are reluctant to invest in expensive point-of-sale upgrades to accommodate digital asset payments directly. As yet another reason, many digital asset payments are public and expose sensitive merchant/customer information.

While some digital wallet applications enable retail blockchain payments, they are dependent on existing payment networks and thus are susceptible to the fraud attacks of the existing payment networks. For example, a digital asset is linked to a payment card (e.g., a credit card, debit card, gift card, etc.), where a digital asset payment is converted and conducted as a payment card transaction and, thus susceptible to the same fraud attacks as the payment card. Further, a billing address and/or other personal customer information may be required for a merchant to verify traditional payment card payments. A merchant may store this information which consumes data storage space and renders additional private customer information vulnerable to theft and fraud. Additionally, the costs of the existing payment network (e.g., payment transaction costs, fees, etc.) are maintained. Adding a digital asset payment option within an existing payment network only increases those costs.

Further, other digital wallet applications that enable retail blockchain payments may require that consumers store their digital assets with the entity that is facilitating the payment such that digital assets can be exchanged and sent to a merchant without the delay of confirming the digital assets sent by a consumer. Thus, the consumer gives up control of their digital assets in order to conduct payments in this manner. Further, when using existing digital asset-based payment systems, a consumer must use the digital wallet application associated with the entity that is facilitating the payment (e.g., the entity that storing digital assets on behalf of a consumer). The consumer therefore lacks the flexibility and freedom of spending from a digital wallet application of their choice.

Even though digital asset-based interactions such as cryptocurrency payments significantly reduce fraudulent activity as compared to traditional payments, fraudulent digital asset-based interactions are possible. For example, malicious users can manipulate a cryptocurrency blockchain to “double spend” (e.g., create one transaction within a block to transfer an amount to a merchant and create another block without that transaction such that the transfer to the merchant does not exist). As another example, malicious or faulty digital wallet software can prevent a digital asset transaction from being authorized and completed correctly.

The digital asset-based interaction system 10 facilitates secure, fraud-less, real-time digital asset-based interactions (e.g., digital asset payments) between source computing entities wishing to use digital assets and destination computing entities wishing to receive desired assets where source computing entities can maintain control of their own digital assets and provide digital assets from a variety of digital asset wallet applications (e.g., asset management units) that are not associated with the digital asset-based interaction system 10 (e.g., associated with the digital asset-based interaction computing entity 16).

As used herein, a computing entity may be one or more computing devices, one or more distributed computing devices, and/or one or more modules executing on one or more computing devices. Within the digital asset-based interaction system 10, the source computing entity 12, the destination computing entity 14, the digital asset-based interaction computing entity 16, the digital asset backing computing entity 20, the one or more digital asset exchange computing entities 22, and the one or more staking computing entities 24 may be one or more computing devices, may be one or more distributed computing devices, and/or one or more modules executing on one or more computing devices.

As used herein, a computing device may be one or more portable computing devices and/or one or more fixed computing devices. The source computing entity 12, the destination computing entity 14, the digital asset-based interaction computing entity 16, the digital asset backing computing entity 20, the one or more digital asset exchange computing entities 22, and the one or more staking computing entities 24 may be one or more portable computing devices and/or one or more fixed computing devices. A portable computing device may be a social networking device, a gaming device, a cell phone, a smart phone, a digital assistant, a digital music player, a digital video player, a laptop computer, a handheld computer, a tablet, a video game controller, a virtual reality (VR) computing device, a portable merchant point-of-sale (POS) device (e.g., a mobile device with POS capabilities) and/or any other portable device that includes a computing core. A fixed computing device may be a computer (PC), a computer server, a cable set-top box, a satellite receiver, a television set, a printer, a fax machine, home entertainment equipment, a video game console, a fixed merchant point-of-sale (POS) device (e.g., attended cash register, unattended register, etc.), and/or any type of home or office computing equipment.

The source computing entity 12 includes an asset management unit 30 that stores digital assets 34. While only one asset management unit 30 is shown, the source computing entity 12 may include more than one asset management unit. In this example, the asset management unit 30 is storing one type of digital asset (e.g., digital assets 34) for simplicity, but in other embodiments, the source computing entity 12 may store a variety of types and/or amounts of digital assets.

The asset management unit 30 may be a digital wallet application installed on or otherwise usable by the source computing entity 12 that functions to facilitate the storage and management (e.g., buy, sell, trade, custody, etc.) of digital assets 34. The asset management unit 30 is operable to interact with the digital asset distributed ledger technology (DLT) networks (e.g., a blockchain) associated with the digital assets it stores and manages. The asset management unit 30 includes a combination of a public address and a private key.

In this example, the asset management unit 30 is a non-custodial digital wallet application that may be associated with a non-custodial digital asset management computing entity (e.g., a digital asset exchange company) where the asset management unit 30 stores digital assets and the source computing entity 12 manages private keys to the asset management unit 30.

The asset management unit 30 may be a custodial digital wallet application associated with a digital asset management computing entity that may be specially licensed and insured to hold digital assets (e.g., a digital asset holding and management company, a cryptocurrency holding company, a cryptocurrency holding and exchange company, etc.). The digital asset management computing entity (i.e., “the custodian”) of a custodial digital wallet application holds the private key needed to gain access to digital assets.

In this example, the asset management unit 30 is not associated with the digital asset-based interaction computing entity 16, but in other embodiments, the asset management unit 30 may be a custodial or non-custodial digital wallet application associated with the digital asset-based interaction computing entity 16 (e.g., via a source computing entity digital asset-based interaction interface). Alternatively, an asset management unit 30 may be a network enabled smart contract application. A network enabled smart contract application allows a user to upload digital assets to a network enabled smart contract using a private key (e.g., non-custodial) and eliminates double spending issues associated with non-custodial wallets.

The destination computing entity 14 may be associated with a particular merchant that facilitates payments from the source computing entity 12 to the merchant. For example, the destination computing entity 14 may be a fixed POS computing device, a merchant e-commerce website, a merchant mobile application (“app”), etc. The destination computing entity 14 may include payment features tailored to the type of destination computing entity 14 involved in a payment. For example, when the destination computing entity 14 is a fixed POS computing device (e.g., a register), the destination computing entity 14 includes features for an in-person payment interaction (e.g., a scanning device, a touchscreen, a receipt printer, etc.).

As another example, when the destination computing entity 14 is an e-commerce website or merchant mobile application (“app”), the destination computing entity 14 may include a variety of existing payment processing features (e.g., existing hardware and/or software) for processing online payments within existing payment networks (e.g., an Secure Socket Layers (SSL) certificate, e-commerce shopping cart software, order and product management features, customer profile management capabilities, a payment gateway, an e-commerce merchant account with a processing bank to accept credit and debit card payments, etc.).

The destination computing entity 14 includes a digital asset-based interaction interface 32 operable to interface with the digital asset-based interaction computing entity 16. For example, the digital asset-based interaction interface 32 are digital asset-based interaction computing entity application programming interfaces (APIs) integrated into the destination computing entity 14 that allow the destination computing entity 14 to connect to the digital asset-based interaction computing entity 16 for digital asset-based interactions.

The destination computing entity 14 may include an asset management unit that includes the digital asset-based interaction interface 32. When the destination computing entity 14 is associated with a merchant, its asset management unit may be an application that facilitates receiving assets during an interaction such as POS software and/or hardware that may or may not include a digital wallet function depending on the types of assets the destination computing entity 14 wishes to accept and the desired method of receiving those assets.

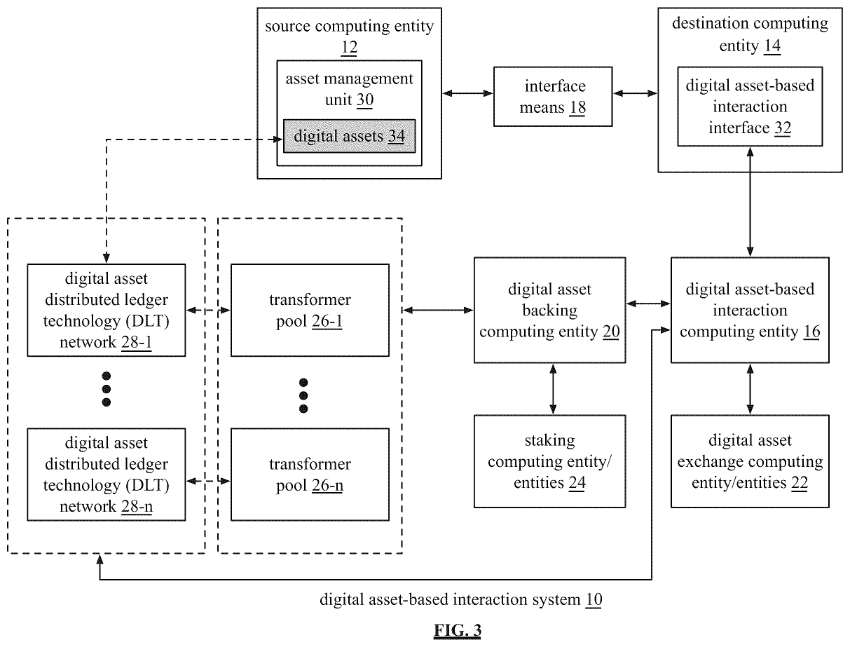

The digital asset DLT network 28 is a digital system associated with the digital assets 34 stored by asset management unit 30. A digital asset DLT network 28 includes a plurality of consensus network computing entity nodes operable to implement a validation procedure to verify the authenticity of transactions recorded on a distributed ledger. For example, the validation procedure is a consensus method. Examples of consensus methods include proof-of-work, proof-of-stake, Practical Byzantine Fault Tolerance (PBFT), and Directed Acyclic Graph (DAG). The plurality of consensus computing entity nodes executes the validation procedure to validate and broadcast transactions to the distributed ledger stored by each consensus network computing entity node of the plurality of consensus network computing entity nodes. The digital asset DLT network 28 and consensus network computing entity nodes will be discussed in more detail with reference to FIG. 3A.

A digital asset DLT network 28 may be a multi-layer digital asset DLT network. A multi-layer digital asset DLT network is a digital system associated with a particular digital asset that includes an on-main ledger layer and one or more off-main ledger layers. For example, when an on-main ledger layer has a blockchain data structure, the additional layers to the on-main ledger layer (e.g., a main blockchain) may include one or more nested blockchains, state channels, and sidechains.

The one or more digital asset exchange computing entities 22 are online platforms that allow users to trade digital assets for other forms of digital assets or other assets such as conventional government-issued fiat currency and/or other digital currencies. The one or more digital asset exchange computing entities 22 may be associated with one or more trusted third parties to that may be specially licensed to facilitate exchanges when licensing is required. In an embodiment, the digital asset-based interaction computing entity 16 is a digital asset exchange computing entity where the digital asset exchange computing entity 16 may be specially licensed for exchange when licensing is required.

In another embodiment, the one or more digital asset exchange computing entities 22 may form a decentralized marketplace that does not involve a trusted third party and facilitates peer-to-peer exchanges. In another embodiment, the digital asset-based interaction computing entity 16 and/or the one or more digital asset exchange computing entities 22 may be associated with one or more digital asset holding companies. A digital asset holding company stores sensitive materials and has insurance policies to protect against theft and fraud. A digital asset holding company may be specially licensed for holding digital assets when licensing is required.

The digital asset backing computing entity 20 may be a part of or separate from the digital asset-based interaction computing entity 16. The digital asset backing computing entity 20 manages the storage and use of system digital assets (e.g., system cryptocurrency, system tokens, etc.) for collaterally backing digital asset-based interactions. System digital assets are digital assets that serve as collateral to back digital asset-based interactions of the digital asset-based interaction system 10.

The system digital assets may be any digital asset that the digital asset-based interaction system chooses to use. For example, the system digital asset is a token on the Ethereum blockchain specifically created for use in the digital asset-based interaction system. As another example, the system digital asset is an already established and trusted cryptocurrency. The digital asset backing computing entity 20 also manages information associated with the one or more staking computing entities 24 such as identifying information of the one or more staking computing entities 24, system digital asset balances and availability, rewards calculations, etc.

The one or more staking computing entities 24 may be one or more user computing devices, one or more merchant computing entities, a digital asset management computing entity associated with an asset management unit, one or more computing entities associated with a corporation and/or business, etc. The one or more staking computing entities 24 (e.g., a user computing device, etc.) are associated with the digital asset backing computing entity 20 via an account (e.g., a stake account). The staking computing entities 24 provide the digital asset backing computing entity 20 with system digital assets and instructions on how to stake the system digital assets. For example, the staking computing entities 24 provide the digital asset backing computing entity 20 instructions to stake (i.e., back) the digital asset DLT network 28 with an amount of system digital assets.

Backing the digital asset DLT network 28 means that a particular consensus network computing entity node of the digital asset DLT network 28 is backed to ensure transactions are written onto the ledger. A consensus network computing entity node of the digital asset DLT network 28 may be associated with the digital asset-based interaction computing entity 16. Backing a particular consensus network computing entity node of the digital asset DLT network 28 is necessary for backing digital asset-based interactions involving digital assets stored in a non-custodial asset management unit not associated with the digital asset-based interaction computing entity 16 because the non-custodial asset management unit is interfacing directly with the digital asset DLT network 28 when initiating digital asset-based interactions. When a digital asset-based interaction involves digital assets stored in a custodial asset management unit, the custodial asset management unit is backed rather than a particular consensus network computing entity node of the digital asset DLT network because the custodian (e.g., a digital asset management computing entity) interacts with the digital asset DLT network on behalf of the source computing entity 12.

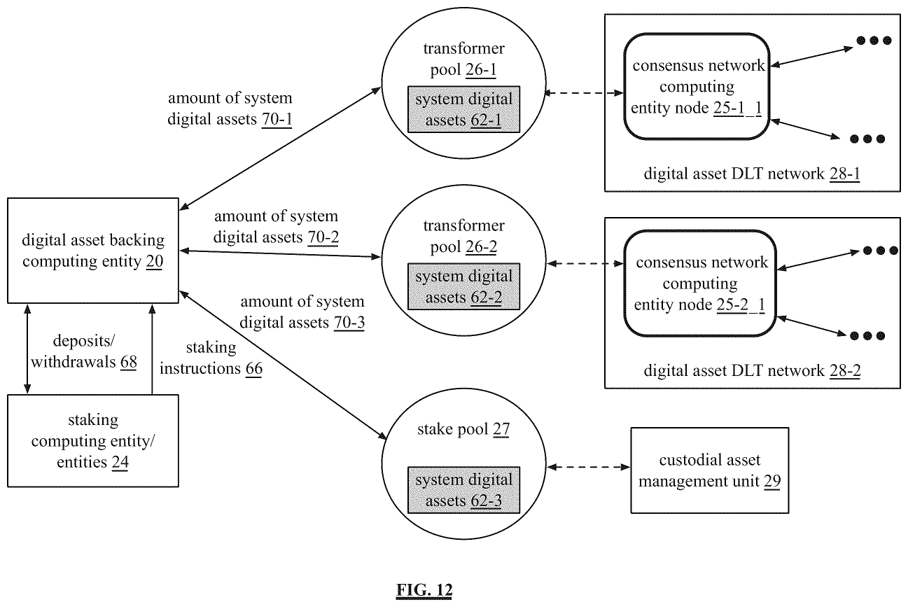

The transformer pool 26 is a smart contract (e.g., an Ethereum smart contract) that stores system digital assets to back digital asset-based interactions involving digital assets 34 stored in a non-custodial asset management unit 30 associated with the digital asset DLT network 28. When the one or more staking computing entities 24 (e.g., a user computing device, etc.) deposit system digital assets with the digital asset backing computing entity 20, the digital asset backing computing entity 20 keeps track of the deposits within the staking computing entity's account and is further operable to deposit an amount of the system digital assets into a particular transformer pool in accordance with system digital asset instructions (e.g., what digital asset DLT networks a staking computing entity wishes to back and for how much). The one or more staking computing entities 24, the digital asset backing computing entity 20, and the transformer pool 26 will be discussed in more detail with reference to FIGS. 12-15.

Because the transformer pool 26 stores system digital assets to back digital asset-based interactions involving digital assets 34, the source computing entity 12 may use the digital assets 34 for digital asset-based interactions within the digital asset-based interaction system 10 regardless of asset management unit 30 used to store the digital assets 34. Thus, the source computing entity 12 has the freedom and flexibility to use the asset management unit 30 of its choosing while still benefiting from the secure and fast digital asset-based interaction processing of the digital asset-based interaction system 10.

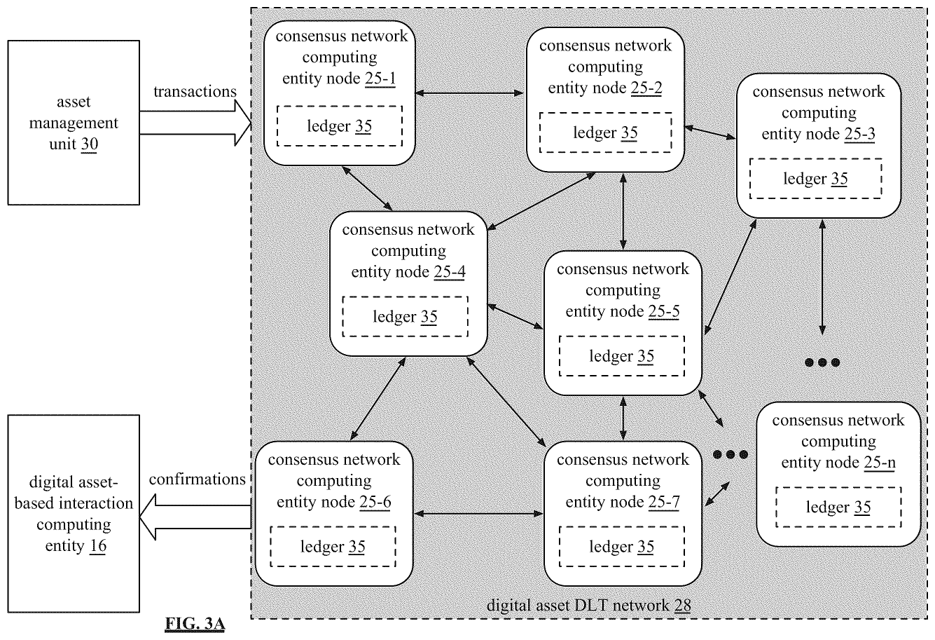

The source computing entity 12 and the destination computing entity 14 interact via one or more interface means 18. For example, the source computing entity 12 and the destination computing entity 14 interact to initiate a digital asset-based interaction (may also be referred to herein as “interaction”). Initiation of a digital asset-based interaction will be discussed in further detail with reference to FIG. 4.

The interface means 18 includes one or more of: a direct link and a network connection. The direct link includes one or more of: a scanning device (e.g., video, camera, infrared (IR), barcode scanner, etc.), radio frequency (RF), and/or near-field communication (NFC). The network connection includes one or more local area networks (LAN) and/or one or more wide area networks (WAN), which may be a public network and/or a private network. A LAN may be a wireless-LAN (e.g., Wi-Fi access point, Bluetooth, ZigBee, etc.) and/or a wired LAN (e.g., Firewire, Ethernet, etc.). A WAN may be a wired and/or wireless WAN. For example, a LAN is a personal home or business's wireless network and a WAN is the Internet, cellular telephone infrastructure, and/or satellite communication infrastructure.

As an example, the source computing entity 12 is a smart phone, the destination computing entity 14 is a fixed merchant POS computing device (e.g., a POS register) and the interface means 18 is the fixed merchant POS computing device's scanning device (e.g., camera, barcode scanner, etc.). As another example, the source computing entity 12 is a smart phone, the destination computing entity 14 is a fixed merchant POS device (e.g., a POS register) and the interface means 18 is the smart phone's scanning device (e.g., a front or back camera).

As another example, the source computing entity 12 is a smart phone, the destination computing entity 14 is an online POS connection device (e.g., an e-commerce website or e-commerce mobile app) and the interface means 18 is a network connection. For example, a smart phone uses an internet browser application (via cellular or wireless internet connection) to access a merchant's e-commerce website. As another example, a smart phone uses a network connection to connect to an installed merchant e-commerce mobile app.

As yet another example, a combination of interface means 18 is possible. For example, the source computing entity 12 is a smart phone and the destination computing entity 14 is an online POS connection device (e.g., an e-commerce website). The e-commerce website is accessed via a network connection interface means 18 on a computing device associated with the user of the source computing entity 12 (e.g., a laptop or desktop computer). The computing device displays information for use by the source computing entity's scanning device (e.g., front or back camera).

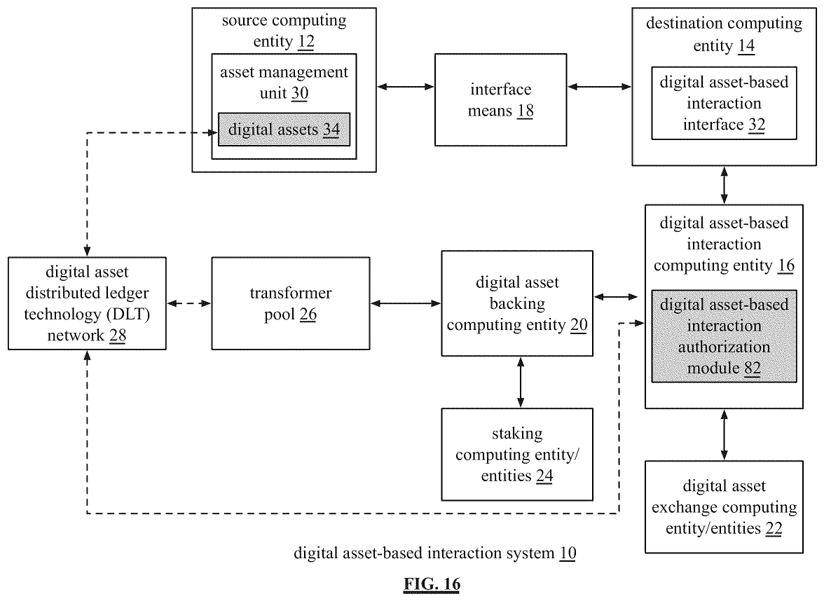

The digital asset-based interaction computing entity 16 is operable to facilitate digital asset-based interactions between the source computing entity 12 and the destination computing entities 14 by performing a real-time digital asset-based interaction process and a nonreal-time digital asset-based interaction process to reconcile the real-time digital asset-based interaction process with the digital asset backing computing entity 20. The digital asset-based interaction computing entity 16 is also operable to authorize digital asset-based interactions in accordance with system authorization parameters. Authorizing digital asset-based interactions will be discussed in more detail with reference to FIGS. 16-24.

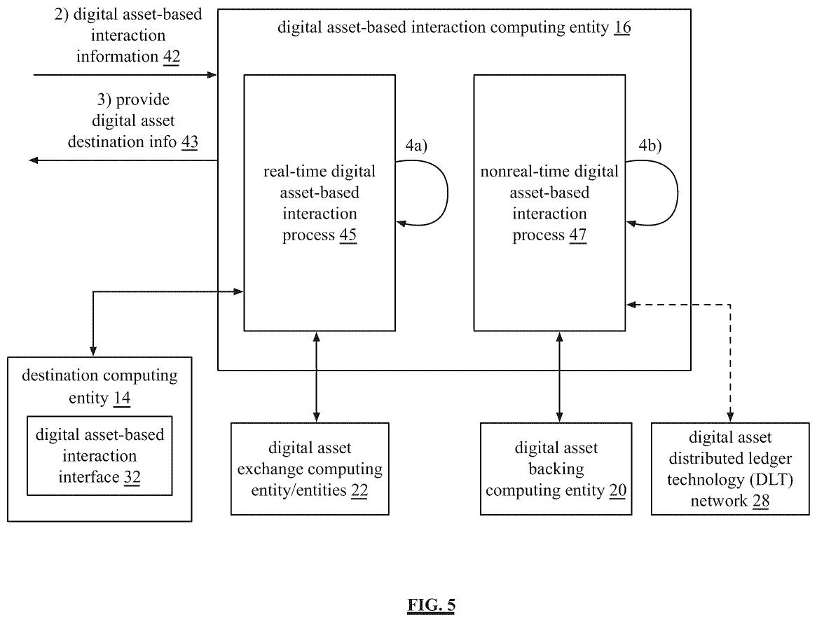

To perform the real-time digital asset-based interaction process, the digital asset-based interaction computing entity 16 is operable to connect to the one or more digital asset exchange computing entities 34 to convert digital assets to one or more desired assets (e.g., fiat currency, another digital asset, whatever asset format is desired by the destination computing entity 14) and send the desired assets to the destination computing entity 14. The real-time digital asset-based interaction process will be discussed in greater detail with reference to FIGS. 6 and 8-10.

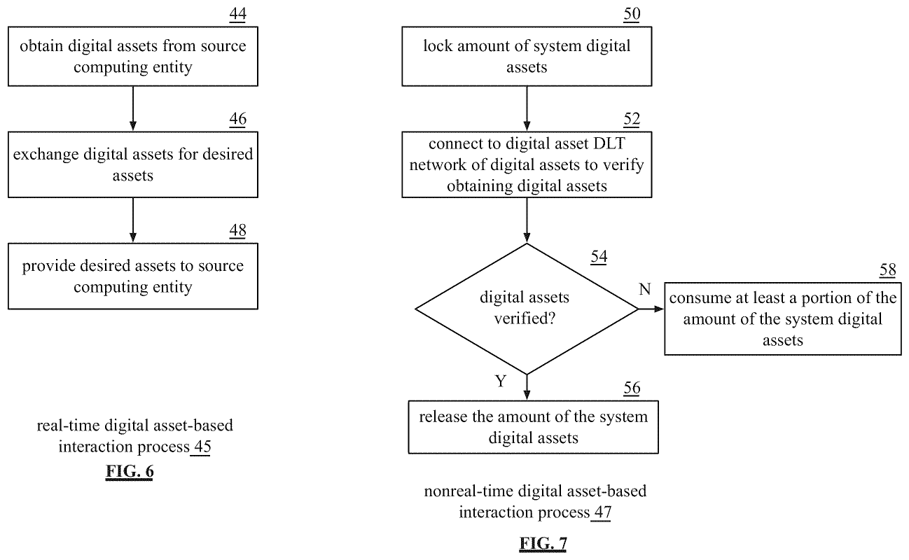

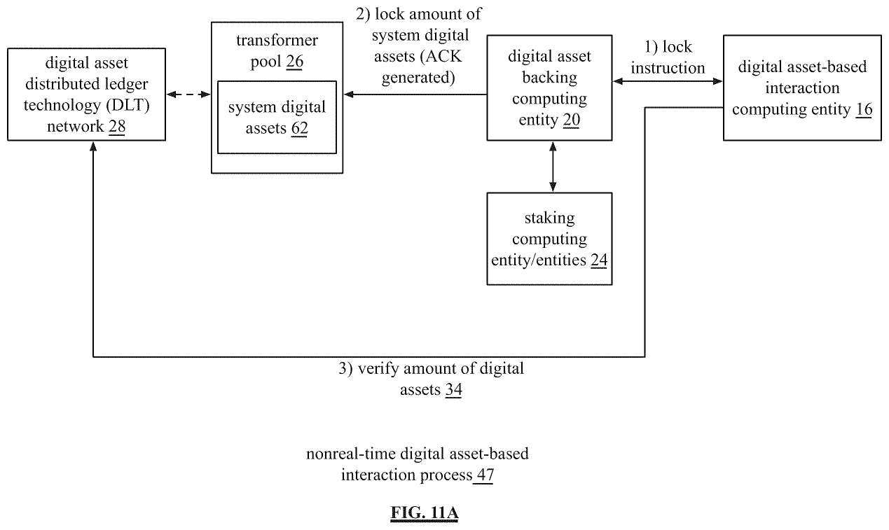

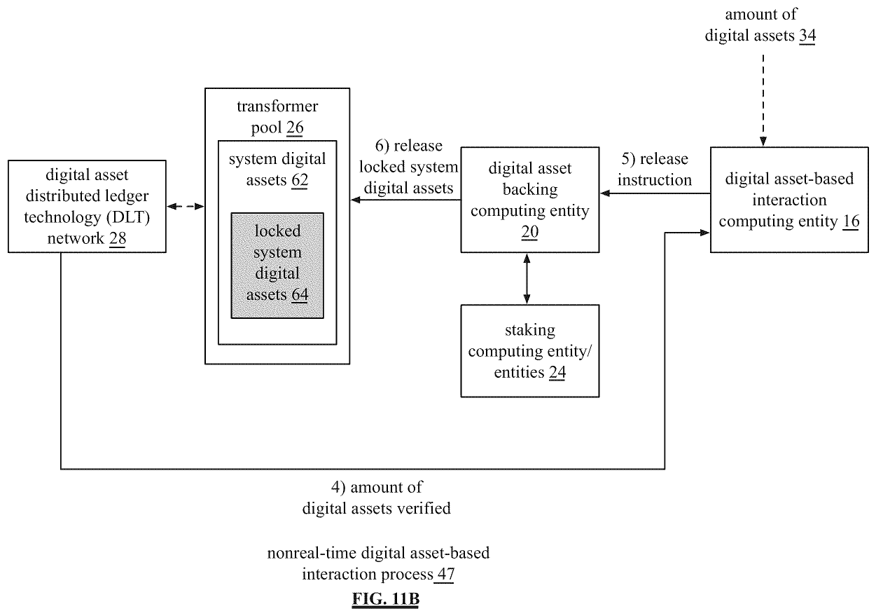

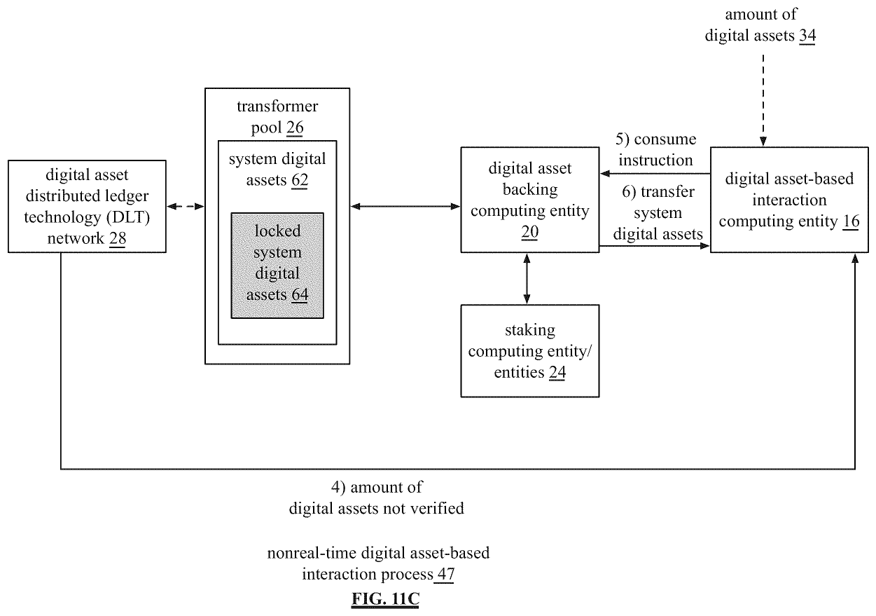

To perform the nonreal-time digital asset-based interaction process, the digital asset-based interaction computing entity 16 is operable to communicate with the digital asset backing computing entity 20 to back digital asset-based interactions such that they can be authorized and/or completed successfully in real-time and connect to the digital asset distributed ledger technology (DLT) network 28 associated with the digital assets to verify receipt of digital assets. The nonreal-time digital asset-based interaction process will be discussed in greater detail with reference to FIGS. 7 and 11A-11C.

The digital asset-based interaction computing entity 16 may be associated with a stored value account (SVA) device where the SVA device is associated with the destination computing entity 14 (e.g., a destination computing entity 14 has an SVA account with the SVA device) such that an SVA is generated for payment. In another embodiment, the digital asset-based interaction computing entity 16 is operable to generate stored value accounts (SVAs). Generation of SVAs for transactions is described in co-pending patent application Ser. No. 16/376,911, entitled, “SECURE AND TRUSTED DATA COMMUNICATION SYSTEM,” filed Apr. 5, 2019.

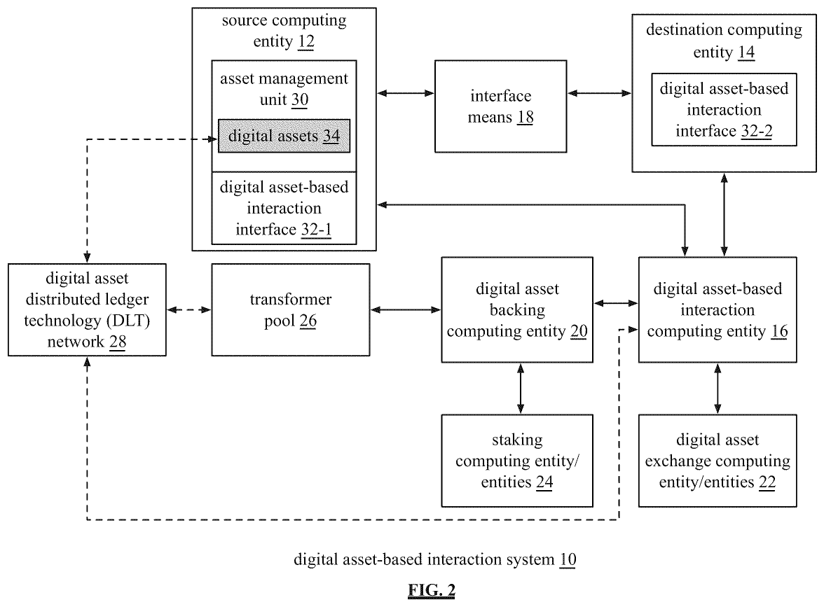

FIG. 2 is schematic block diagram of another embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, a transformer pool 26, and a digital asset distributed ledger technology (DLT) network 28.

The digital asset-based interaction system 10 of FIG. 2 operates similarly to the digital asset-based interaction system 10 of FIG. 1 except that the destination computing entity 14 includes a digital asset-based interaction interface 32-2 and the asset management unit 30 of the source computing entity 12 includes a digital asset-based interaction interface 32-1 that is associated with the digital asset-based interaction computing entity 16. Even though the source computing entity 12 is not obligated to use an asset management unit 30 associated with the digital asset-based interaction computing entity 16 to conduct digital asset-based interactions with the digital assets 34, the source computing entity 12 could choose to use the asset management unit 30 associated with the digital asset-based interaction computing entity 16 (e.g., with the digital asset-based interaction interface 32-1) for a plurality of other features.

For example, by using the asset management unit 30 with the digital asset-based interaction interface 32-1, the source computing entity 12 is operable to obtain scannable codes from the digital asset-based interaction computing entity 16 to initiate digital asset-based interactions with the destination computing entity 14.

FIG. 3 is schematic block diagram of another embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, a plurality of transformer pools 26-1 through 26-n, and a plurality of digital asset distributed ledger technology (DLT) networks 28-1 through 28-n.

The digital asset-based interaction system 10 of FIG. 3 operates similarly to the digital asset-based interaction system of FIG. 1 except that the digital asset-based interaction system 10 of FIG. 3 includes a plurality of transformer pools 26-1 through 26-n and a plurality of digital asset DLT networks 28-1 through 28-n. For example, a first digital asset DLT network 28-1 is associated with the digital assets 34 and a first transformer pool 26-1 stores system digital assets to back digital asset-based interactions associated with the digital assets 34. As another example, a second digital asset DLT network 28-2 is associated with second digital assets and a second transformer pool 26-2 stores system digital assets to back digital asset-based interactions associated with the second digital assets. As another example, a third digital asset DLT network 28-3 is associated with third digital assets and a third transformer pool 26-3 stores system digital assets to back digital asset-based interactions associated with the third digital assets.

FIG. 3A is a schematic block diagram of an embodiment of a portion of the digital asset-based interaction system that includes an asset management unit 30 (e.g., of the source computing entity), a digital asset-based interaction computing entity 16, and a digital asset distributed ledger technology (DLT) network 28.

The digital asset DLT network 28 includes a plurality of consensus network computing entity nodes 25-1 through 25-n (also referred to herein as nodes) that each store a distributed and replicated ledger 35 and use validation procedures (e.g., consensus methods) to ensure replication across the plurality of consensus network computing entity nodes 25-1 through 25-n is undertaken. Distributed ledgers 35 may be permissioned, permissionless, or hybrid. Consensus methods include proof of work, proof of stake, delegated proof of stake, Byzantine Fault Tolerance, voting systems, etc.

When a user such as the asset management unit 30 submits a new transaction, it is received by a consensus network computing entity node of the plurality of consensus network computing entity nodes 25-1 through 25-n and the consensus network entity node broadcasts the transaction to the rest of the network. When a new transaction on the ledger 35 occurs, each of the consensus network computing entity nodes 25-1 through 25-n construct the new transaction and vote by a consensus method on which copy of the ledger 35 is correct. Once consensus is determined, all consensus network computing entity nodes 25-1 through 25-n update the ledger 35 with the correct copy. Blockchain is a form of digital asset DLT network that uses cryptographic and algorithmic approaches to create and verify a continuously expanding, append-only data structure that gradually turns into a chain of transaction blocks that serve the role of the ledger 35.

In the Bitcoin blockchain, nodes validate transactions and specialized nodes known as miners (or a collective of miners) pick up the transactions and compete to confirm pending transactions. Going from pending to confirmed means that the transaction has been added to the ledger (blockchain). Bitcoin miners batch pending transactions into what are known as blocks. The confirmed block is propagated across the entire network back to all nodes. Once validated, the nodes add the block to the previous block thus creating a blockchain. Some blockchain networks do not require mining such as blockchains that use proof of stake consensus methods where participants must have a stake in the blockchain to select, verify, and validate transactions.

Non-blockchain forms of digital asset DLT networks store transactions in data architectures that differ from blockchains. For example, a hashgraph data structure stores all transactions in a parallel structure. Hashgraphs do not use miners to validate transactions and instead use a “gossip about gossip” consensus method where individual nodes on the network “gossip” about transactions to create directed acyclic graphs that time-sequence transactions without bundling them into blocks.

In this example, the asset management unit 30 is adding one or more transactions (e.g., a digital asset-based interaction may include one or more transactions) to the digital asset DLT network 28. For example, a digital asset-based interaction involving a digital asset associated with the digital asset DLT network 28 is added as a transaction on the ledger 35. To add the transaction on the ledger 35, a particular consensus network computing entity node receives the transaction and broadcasts it to the other consensus network computing entity nodes on the digital asset DLT network 28. The on-ledger transaction includes information related to the asset management unit 30 sending an amount of the digital assets to the digital asset-based interaction computing entity 16. To ensure that the transaction is added to the ledger, the consensus network computing entity node receiving the transaction is backed with system digital assets (e.g., the digital asset DLT network 28 is backed).

The digital asset-based interaction computing entity 16 communicates with the digital asset DLT network 28 to obtain a desired amount of confirmations regarding the digital asset-based interaction transaction added via the asset management unit 30. Based on the type of digital asset DLT network 28 and the validation procedures used by the digital asset DLT network 28, the desired amount of confirmations may take minutes to hours of time to obtain.

FIG. 4 is a flowchart of an example of a method of initiating a digital asset-based interaction between a source computing entity 12 and a destination computing entity 14. FIG. 4 depicts a portion of a digital asset-based interaction system 10 that includes a source computing entity 12, a destination computing entity 14, an interface means 18, a digital asset-based interaction computing entity 16, and one or more digital asset exchange computing entities 22.

The source computing entity 12 includes a plurality of asset management units 30-1 through 30-n. An asset management unit 30-1 stores digital assets 34. In this example, the asset management unit 30-1 is not associated with the digital asset-based interaction computing entity 16. The digital asset-based interaction involves the source computing entity 12 providing an amount of digital assets 34 and the destination computing entity 14 accepting an amount of desired assets.

To initiate the digital asset-based interaction, the method begins with step 1 where the destination computing entity 14 obtains source computing entity information 40 from the source computing entity 12 via the one or more interface means 18. For example, the source computing entity 12 may scan a scannable code presented by the destination computing entity 14 and the scanning causes a pop-up window to appear on a display of the source computing entity 12 for viewing and data input. As another example, the destination computing entity 14 may be a mobile application installed on the source computing entity 12 such that the source computing entity 12 provides information to the destination computing entity 14 via that mobile application interface (e.g., a network connection).

The source computing entity information 40 includes at least identifying information of the source computing entity 12 such as a source computing entity identifier (ID), a name, and/or email address and the type of digital asset it wishes to use. The source computing entity information 40 may include other information such as the asset management unit it wishes to use, an item involved in the digital asset-based interaction, etc.

The method continues with step 2 where the destination computing entity 14 provides digital asset-based interaction information 42 to the digital asset-based interaction computing entity 16 via the digital asset-based interaction information interface 32. The digital asset-based interaction information 42 includes the source computing entity information 40 and destination computing entity 14 information. The destination computing entity 14 information includes at least a destination computing entity identifier (ID) (e.g., a user ID, a merchant ID, a merchant terminal ID, etc.) and the type of desired assets it wishes to receive (e.g., a fiat currency, a cryptocurrency, etc.). One or more of the source computing entity information 40 and the destination computing entity 14 information includes the amount involved in the digital asset-based interaction. The source computing entity information 40 and the destination computing entity 14 information may include further information and/or metadata such as loyalty information, personal information (address, name, etc.), shipping details, bill splitting information, a request for additional information, etc.

When the source computing entity 12 is associated with the digital asset-based interaction computing entity 16, the digital asset-based interaction computing entity 16 can obtain the source computing entity information 40 from the source computing entity 12 directly. Further, when the source computing entity 12 is associated with the digital asset-based interaction computing entity 16, the source computing entity 12 can obtain the destination computing entity information from the destination computing entity and provide the digital asset-based interaction information 42 to the digital asset-based interaction computing entity 16.

Once the digital asset-based interaction information 42 is received, the method continues with step 3 where the digital asset-based interaction computing entity 16 provides the destination computing entity 14 an address for receiving the digital assets 34 (e.g., digital asset destination information (info) 43). The method continues at step 4 where the destination computing entity 14 provides the digital asset destination information (info) 43 to the source computing entity 12 via the interface means 18. The digital asset destination information (info) 43 is provided based on the capabilities and functionality of the destination computing entity 14 and may be provided by a scannable code, a button, a uniform resource locator (URL) link that includes a means for pushing funds from the source computing entity 12 to an address associated with the digital asset-based interaction computing entity 16.

When the source computing entity 12 is associated with the digital asset-based interaction computing entity 16, the digital asset-based interaction computing entity 16 can provide the digital asset destination information (info) 43 to the source computing entity 12 directly. In another embodiment, when the source computing entity 12 is associated with the digital asset-based interaction computing entity 16, the digital asset-based interaction computing entity 16 may be operable to pull funds from the source computing entity 12.

In a specific example, when the destination computing entity 14 is a fixed merchant POS computing device and the interface means 18 is a scanning device of the source computing entity 12, the destination computing entity 14 presents a quick response (QR) code or other scannable code to the source computing entity 12 to initiate the digital asset-based interaction. When the source computing entity 12 scans the QR code or other scannable code, a window opens on the source computing entity 12 that allows the source computing entity 12 to input the source computing entity information 40 (e.g., the source computing device 12 may be prompted to select an asset management unit 12 to choose from and the type of digital asset to pay with) which is sent to the digital asset-based interaction computing entity 16 via the destination computing entity 14. Through the same window, the destination computing entity 14 can provide the digital asset destination information 43 (e.g., an address of the digital asset-based interaction computing entity 16) via the digital asset-based interaction computing entity 16 to the source computing device 12. The source computing entity 12 can then select a “pay” or “send” option to direct the digital assets 34 to the digital asset-based interaction computing entity 16 via the digital asset destination information 43. In another example, providing the source computing entity information to the digital asset-based computing entity authorizes directing the digital assets 34 such that the source computing entity 12 does not have to select a “pay” or “send” option and the digital assets 34 are sent automatically to an address generated by the digital asset-based interaction computing entity 16.

In an alternative embodiment, the destination computing entity 14 is operable to generate the digital asset destination information 43. For example, the destination computing entity 14 stores at least a portion of the digital asset destination information 43 (e.g., addresses associated with the digital asset-based interaction computing entity 16 where the addresses depend on the types of digital assets used) and generates a dynamic deposit code for each digital asset-based interaction which it can share with the source computing entity 12 and the digital asset-based interaction computing entity 16. The destination computing entity 14 can then provide at least a portion of the digital asset destination information 43 and the dynamic deposit code to the source computing entity 12. The source computing entity 12 can then direct the digital assets to the digital asset-based interaction computing entity 16 using the digital asset destination information 43 and the dynamic deposit code. In another example, the destination computing entity 14 is operable to generate the digital asset destination information 43 using universal routing codes. In another example, the destination computing entity 14 is operable to generate the digital asset destination information 43 prior to obtaining the source computing entity information 40 when the type of the digital assets is known (e.g., the destination computing entity 14 only accepts a certain type of digital asset such as Bitcoin).

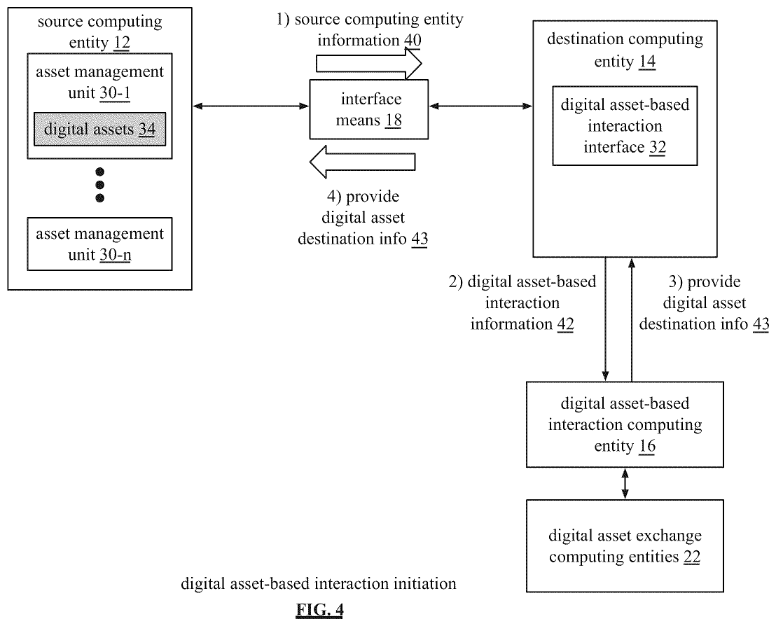

FIG. 5 is a flowchart of an example of a method of a digital asset-based interaction computing entity 16 facilitating a digital asset-based interaction between a source computing entity and a destination computing entity. FIG. 5 depicts a portion of a digital asset-based interaction system that includes a destination computing entity 14, a digital asset-based interaction computing entity 16, one or more digital asset exchange computing entities 22, a digital asset distributed ledger (DLT) network 28, and a digital asset backing computing entity 20.

FIG. 5 continues the example of FIG. 4 where a digital asset-based interaction has been initiated. After the digital asset-based interaction computing entity 16 has received the digital asset-based interaction information 42 at step 2 of FIG. 4 and optionally has provided digital asset destination information 43 (if it has not been provided already) at step 3 of FIG. 4, the method continues with steps 4a and 4b. Steps 4a and 4b may occur simultaneously or at slightly different times (e.g., step 4b may occur slightly before step 4a and vice versa).

At step 4a, the digital asset-based interaction computing entity 16 performs a real-time digital asset-based interaction process 45 ensure complete the real-time digital asset-based interaction between the source and destination computing entities 12-14. To perform the real-time digital asset-based interaction process, the digital asset-based interaction computing entity 16 is operable to connect to the one or more digital asset exchange computing entities 34 to convert the digital assets 34 to a substantially equivalent amount of desired assets (e.g., fiat currency, another digital asset, whatever asset format is desired by the destination computing entity 14) and send the desired assets to the destination computing entity 14. The real-time digital asset-based interaction process 45 will be discussed in greater detail with reference to FIGS. 6 and 8-10.

At step 4b, the digital asset-based interaction computing entity 16 performs a nonreal-time digital asset-based interaction process 47 to reconcile the real-time digital asset-based interaction process with the digital asset backing computing entity 20. To perform the nonreal-time digital asset-based interaction process 47, the digital asset-based interaction computing entity 16 is operable to communicate with the digital asset backing computing entity 20 to back digital asset-based interactions such that they can be authorized and/or completed successfully in real-time and connect to the digital asset DLT network 28 associated with the digital assets 34 to verify receipt of digital assets 34. The nonreal-time digital asset-based interaction process will be discussed in greater detail with reference to FIGS. 7 and 11A-11C.

FIG. 6 is a flowchart of an example of a method of a real-time digital asset-based interaction process 45 executable by a digital asset-based interaction computing entity of a digital asset-based interaction system. The method begins with step 44 where the digital asset-based interaction computing entity obtains an amount of digital assets from a source computing entity to use in a digital asset-based interaction. The digital asset-based interaction involves a source computing entity providing digital assets and a destination computing entity accepting desired assets. The destination computing entity is associated with the digital asset-based interaction computing entity.

When the amount of the digital assets obtained by the digital asset-based interaction computing entity from the source computing entity to use in the digital asset-based interaction, a network acknowledgment (ACK) of the receipt of the amount of the digital assets is generated and an authorization process begins. The authorization process will be discussed in more detail with reference to FIGS. 16-24.

Because the digital assets sent by the source computing entity are managed by a digital asset distributed ledger technology network (e.g., the digital assets are cryptocurrency), sending the amount of digital assets to the digital asset-based interaction computing entity is a transaction added to the digital asset DLT network associated with the digital assets used by the source computing entity (e.g., this information is published). However, other details related to the interaction (e.g., the identity of the destination computing entity, transaction fees owed by the destination computing entity, etc.) may be managed privately by the digital asset-based interaction computing entity off-ledger (i.e., off-chain when the distributed ledger technology is blockchain). Therefore, the digital asset-based interaction system is operable to keep confidential destination computing entity related information (e.g., revenue, consumer spending behavior, etc.) and confidential source computing entity related information (e.g., consumer identity of purchases, amount spent at a particular merchant, payees/merchants frequented, etc.) private (i.e., not published on a blockchain for anyone to see).

When the digital asset-based interaction is authorized (e.g., the authorization process is successful), the method continues with step 46 where the digital asset-based interaction computing entity connects to one or more digital asset exchange entities to exchange the amount of the digital assets received from the source computing entity to an amount of desired assets. Digital asset exchange is done quickly (e.g., 30 seconds to a few minutes) to account for exchange rate volatility. The exchange can also be performed immediately on a credit-based account to eliminate any pricing volatility.

The method continues with step 48 where the digital asset-based interaction computing entity sends the amount of desired assets to the destination computing entity. For example, the digital asset-based interaction computing entity sends the desired assets to a banking computing entity associated with the destination computing entity. As another example, the digital asset-based interaction computing entity directs the desired assets to a wallet address associated with the destination computing entity.

FIG. 7 is a flowchart of an example of a method of a nonreal-time digital asset-based interaction process 47 executable by a digital asset-based interaction computing entity of a digital asset-based interaction system. The nonreal-time digital asset-based interaction process 47 of FIG. 7 occurs concurrently with the real-time digital asset-based interaction process 45 of FIG. 6. However, the nonreal-time digital asset-based interaction process 47 occurs over a longer period of time (e.g., minutes to hours) than the real-time digital asset-based interaction process 45 (e.g., seconds).

The method begins with step 50 where the digital asset-based interaction computing entity instructs a digital asset backing computing entity of the digital asset-based interaction system to lock an amount of system digital assets stored in a transformer pool associated with the digital asset distributed ledger technology (DLT) network associated with the digital assets involved in the digital asset-based interaction. The digital asset-based interaction involves a source computing entity providing the digital assets and a destination computing entity accepting desired assets. The destination computing entity is associated with the digital asset-based interaction computing entity.

The digital asset backing computing entity may be a part of or separate from the digital asset-based interaction computing entity. The digital asset backing computing entity manages the storage and use of system digital assets (e.g., system cryptocurrency, system tokens, etc.) for collaterally backing digital asset-based interactions. System digital assets are digital assets that serve as collateral to back digital asset-based interactions of the digital asset-based interaction system. One or more staking computing entities provide the digital asset backing computing entity with system digital assets and instructions on how to stake the system digital assets. For example, one or more staking computing entities provided the digital asset backing computing entity system digital assets to back a digital asset DLT network associated with the digital assets used by the source computing entity in the digital asset-based interaction. A transformer pool is a smart contract that stores system digital assets to back the digital asset DLT network. The one or more staking computing entities, the digital asset backing computing entity, and the transformer pool will be discussed in more detail with reference to FIGS. 12-15.

The amount of system digital assets locked may be based on a variety of factors such as the amount of the digital asset-based interaction (e.g., the amount of system digital assets is substantially equivalent to the amount of the digital asset-based interaction), the item involved in the digital asset-based interaction (e.g., the amount of system digital assets may be a certain amount more than the amount of the digital asset-based interaction when certain types of goods, such as luxury goods, are involved), source computing entity information (e.g., if the source computing entity has a history of fraudulent interactions, the amount of system digital assets may be a certain amount more than the amount of the digital asset-based interaction), destination computing entity information (e.g., merchant-based requirements, default settings), a type of digital asset-based interaction (e.g., authorization holds such as for hotel room purchase may require a certain amount of system digital assets more than the amount of the digital asset-based interaction), digital asset backing computing entity default settings, etc.

If the digital asset-based interaction initiation is terminated (e.g., interaction initiation fails and/or is cancelled by the source and/or the destination computing entity) or the digital asset-based interaction is not authorized during the authorization process within a certain amount of time prior to the digital asset-based interaction computing entity exchanging the digital assets to the desired asset format (e.g., step 46 of FIG. 6), the digital asset-based interaction computing entity instructs the digital asset backing computing entity to release the amount of locked system digital assets (e.g., the method branches to step 56).

Step 50 of FIG. 7 may occur before, concurrently, or after step 44 (but before step 46) of FIG. 6. If step 50 occurs before step 44 of FIG. 6, an acknowledgement (ACK) may be generated. For example, locking the system digital assets implies authorization of the digital asset-based interaction, and the digital asset-based interaction computing entity allows a time period (e.g., up to five minutes) prior to obtaining digital assets from the source computing entity (e.g., the first computing entity has time to add tip, split payment with another user, adjust type of digital asset used, etc.). The destination computing entity is provided a confirmation of this ACK. For example, when the destination computing entity is a POS computing device such as an attended register, this ACK may successfully end the in-person transaction such that a merchant and customer can part ways. However, the destination computing entity receives the payment up to a few minutes later.

When the digital asset backing computing entity locks the amount of the system digital assets, a rate quote for the amount of digital assets used by the source computing entity is locked. An exchange rate is a price at which one digital asset will be exchanged for another. A rate quote is an exchange rate at a given point in time as determined by a digital asset exchange (e.g., cryptocurrency exchange) based on the buying and selling activity of the digital assets within the exchange.

The method continues with step 52 where the digital asset-based interaction computing entity connects to the digital asset DLT network associated with the digital assets used by the source computing entity to verify obtaining the digital assets. The digital asset DLT network implements a validation procedure that may take minutes to hours of time.

For example, in the Bitcoin blockchain, miners record new transactions into blocks that verify all previous transactions within the blockchain. At the filing of this application, it takes a miner ten minutes, on average, to write a block on the Bitcoin blockchain. The average block time depends on a total hash power of the Bitcoin network. Once a block is created and a new transaction is verified and included in a block, the transaction will have one confirmation. Each subsequent block (which verifies the previous state of the blockchain) provides one additional network confirmation.

Typically, between 5-10 transaction confirmations (depending on the monetary value of the transaction) are acceptable for cryptocurrency exchanges to avoid losses due to potential fraud. Therefore, if the source computing entity is using Bitcoin, the digital asset-based interaction computing entity seeks a desired number of confirmations of the amount of the Bitcoin received by the source computing entity from the digital asset DLT network (e.g., via Bitcoin miners). The transaction may not be verified by the digital asset-based interaction computing entity for an hour or more. As such, the nonreal-time digital asset-based interaction process takes longer than the real-time digital asset-based interaction process of the digital asset-based interaction.

The method continues with step 54 where the digital asset-based interaction computing entity determines whether the amount of digital assets is verified (e.g., the digital asset-based interaction computing entity obtains results from the digital asset DLT network regarding whether the amount of the digital assets is verified). When the amount of digital assets is verified, the method continues with step 56 where the digital asset-based interaction computing entity instructs the digital asset backing computing entity to release the amount of system digital assets associated with the digital asset-based interaction. When the amount of digital assets is not verified, the method continues with step 58 where the digital asset-based interaction computing entity instructs the digital asset backing computing entity to consume at least a portion of the amount of system digital assets associated with the digital asset-based interaction.

For example, if fraudulent activity occurs (e.g., the source computing entity acts maliciously to spend at two merchants simultaneously, software of the asset management unit is corrupted, etc.), the amount of the digital assets cannot be verified and the digital asset-based interaction computing entity consumes at least a portion of the amount of system digital assets associated with the digital asset-based interaction. As a specific example, if the source computing entity attempts to double spend a transaction, the verification (e.g., the desired number of confirmations in a Bitcoin blockchain example) will not be received and the digital asset-based interaction computing entity will not be able to verify the amount of the digital asset received by the source computing entity.

Consuming the amount of system digital assets means that the amount of system digital assets is transferred (e.g., via an on-chain transaction) from an address associated with the transformer pool to an address associated with the digital asset-based interaction computing entity. When the amount of system digital assets is more than the amount of the digital asset-based interaction, only a portion of the amount of system digital assets (to cover the digital asset-based interaction) may be consumed while the remainder is unlocked. In another example, regardless of whether the amount of system digital assets is more than the amount of the digital asset-based interaction, the entire amount of the of system digital assets may be consumed.

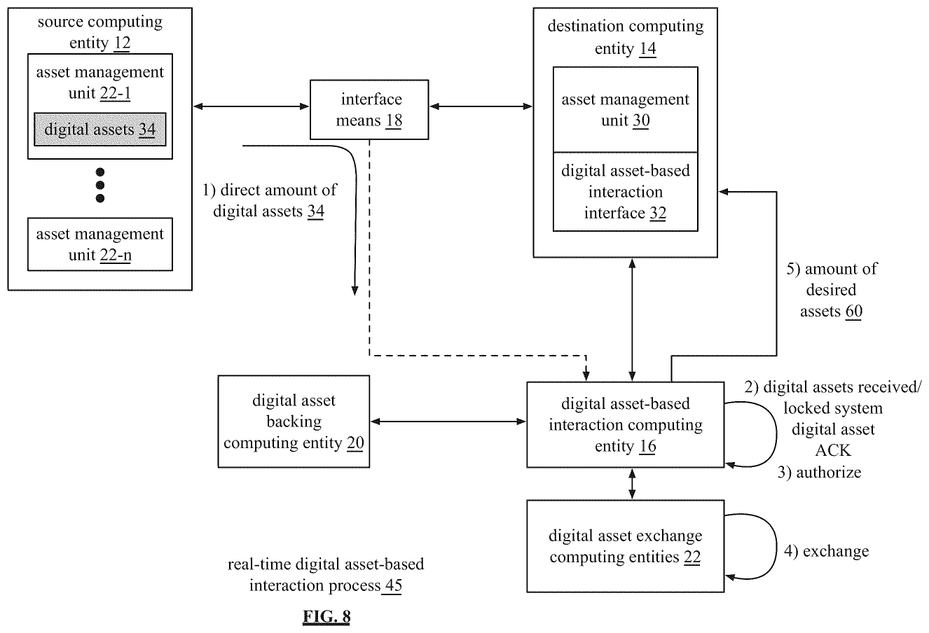

FIG. 8 is a flowchart of an example of a method of a real-time digital asset-based interaction process 45 executable by a digital asset-based interaction computing entity 16 of a digital asset-based interaction system. FIG. 8 depicts a portion of the digital asset-based interaction system 10 that includes a source computing entity 12, a destination computing entity 14, an interface means 18, a digital asset-based interaction computing entity 16, a digital asset backing computing entity 20, and one or more digital asset exchange computing entities 22.

The source computing entity 12, the destination computing entity 14, the interface means 18, the digital asset-based interaction computing entity 16, the digital asset backing computing entity 20, and the one or more digital asset exchange computing entities 22 of FIG. 8 operate similarly to the source computing entity 12, the destination computing entity 14, the interface means 18, the digital asset-based interaction computing entity 16, the digital asset backing computing entity 20, and the one or more digital asset exchange computing entities 22 of FIG. 1.

The destination computing entity 14 may be a merchant computing entity that is operable to process payments from a source computing entity and includes features tailored to the type of destination computing entity 14 it is (e.g., a scanning device, a touchscreen, mobile payment features, online payment features, etc.). The source computing entity 12 and the destination computing entity 14 interact via one or more interface means 18 as discussed with reference to FIGS. 1 and 4 to initiate a digital asset-based interaction. For example, an interface means 18 is a scanning device of the source computing entity 12 and/or the destination computing entity 14. A digital asset-based interaction involves the source computing entity 12 providing digital assets and the destination computing entity 14 accepting desired assets (e.g., fiat currency or a desired digital asset that differs from the digital asset the source computing entity 12 wishes to use in the interaction).

The method begins with step 1 where the source computing entity 12 directs an amount of digital assets 34 to the digital asset-based interaction computing entity 16 via the interface means 18. For example, the destination computing entity 14 provides the source computing entity 12 with a link (e.g., via a scannable code, a uniform resource locator (URL) link, etc.) to an address associated with the digital asset-based interaction computing entity 16. In this example, the source computing entity 12 is not associated with the digital asset-based interaction computing entity 16 so funds are pushed from the source computing entity 12 to the digital asset-based interaction computing entity 16. In another embodiment, when the source computing entity 12 is associated with the digital asset-based interaction computing entity 16 (e.g., the source computing entity 12 includes an asset management unit having a digital asset-based interaction interface), the digital asset-based interaction computing entity 16 is also operable to pull funds from the source computing entity 12 (e.g., the source computing entity 12 presents a code to the destination computing entity 14, the destination computing entity 14 scans the code to send information to the digital asset-based interaction computing entity 16, and the digital asset-based interaction computing entity 16 pulls funds from the source computing entity 12).

The method continues with step 2 where a network acknowledgment (ACK) of the receipt of the amount of the digital assets and system digital assets locked (e.g., the nonreal-time digital asset-based interaction process step of locking system digital assets occurs before, concurrently, or slightly after the digital assets are obtained) is generated. The method continues with step 3 where an authorization process begins. Authorizing the digital asset-based interaction after locking the system digital assets may be useful when there are multiple parties sharing the same ticket which would require the digital asset-based interaction computing entity 16 to collateralize each digital asset-based interaction involved (where each would need to be authorized separately). The authorization process will be discussed in more detail with reference to FIGS. 16-24.

When the authorization process is successful, the method continues with step 4 where the digital asset-based interaction computing entity 16 connects to one or more digital asset exchange entities 22 to exchange the amount of the digital assets 34 received from the source computing entity 12 to an amount of desired assets 60 (e.g., fiat currency, a digital asset that differs from the digital assets 34). Digital asset exchange is done quickly (e.g., 30 seconds to a few minutes) to account for exchange rate volatility. The exchange can also be performed immediately on a credit-based account to eliminate any pricing volatility.

The method continues with step 5 where the digital asset-based interaction computing entity 16 sends the amount of the desired assets 60 to the destination computing entity 14. For example, the digital asset-based interaction computing entity 16 sends the amount of the desired assets 60 to a banking computing entity associated with the destination computing entity 14. As another example, the digital asset-based interaction computing entity 16 directs the amount of the desired assets 60 to a wallet address associated with the destination computing entity 14.

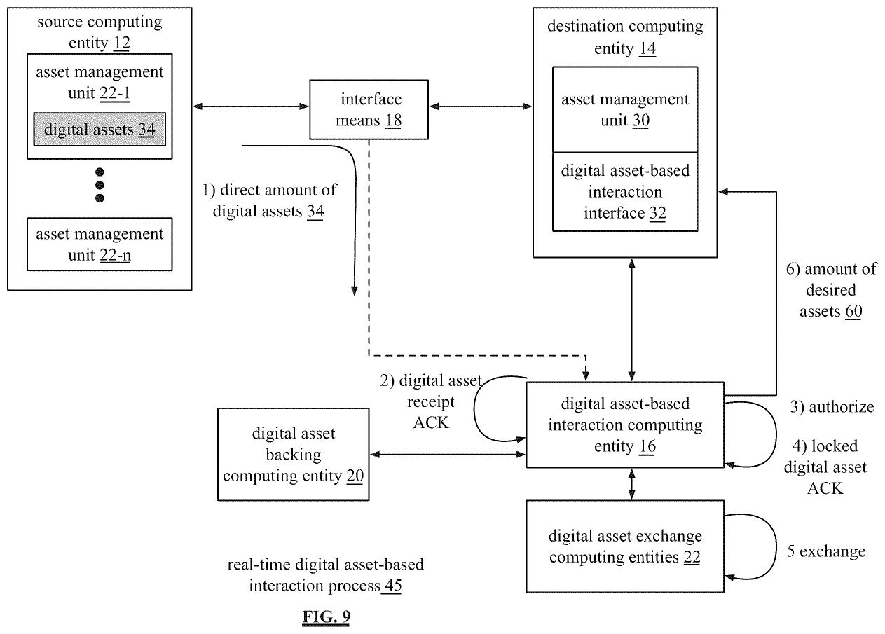

FIG. 9 is a flowchart of an example of a method of a real-time digital asset-based interaction process 45 executable by a digital asset-based interaction computing entity 16 of a digital asset-based interaction system 10. FIG. 9 depicts a portion of the digital asset-based interaction system 10 that includes a source computing entity 12, a destination computing entity 14, an interface means 18, a digital asset-based interaction computing entity 16, a digital asset backing computing entity 20, and one or more digital asset exchange computing entities 22. FIG. 9 operates similarly to the method of FIG. 8 except that the authorization process at step 3 occurs before the locked digital asset acknowledgment (ACK) is generated at step 4 and the locked system digital asset ACK is separate from the digital assets received ACK.

Locking the system digital assets after authorizing the digital asset-based interaction may be useful when authorizing straightforward digital asset-based interactions (e.g., a consumer paying for purchase at an apparel retailer). This would help reduce the unnecessary overhead of locking system digital assets for digital asset-based interactions that are declined. The authorization process will be discussed in more detail with reference to FIGS. 16-24.

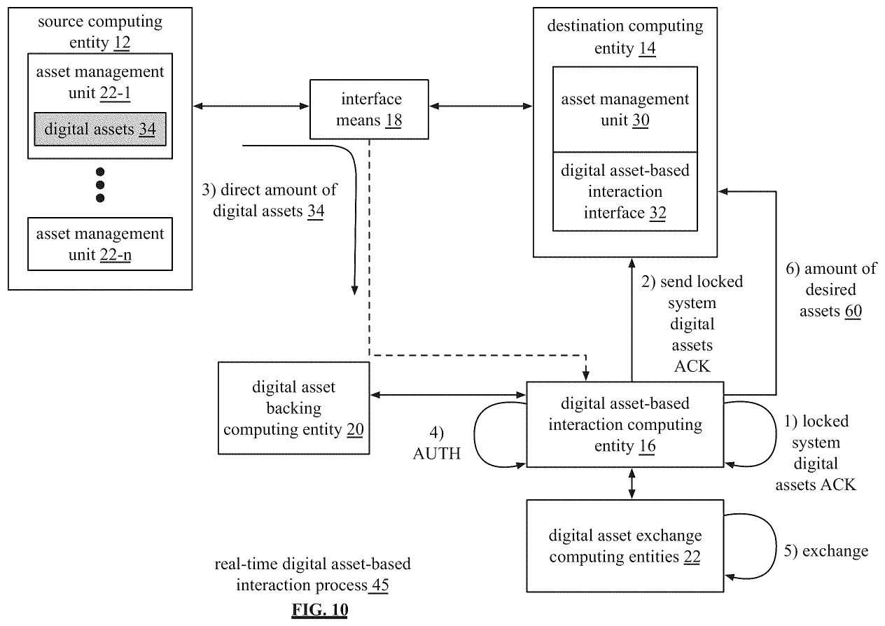

FIG. 10 is a flowchart of an example of a method of a real-time digital asset-based interaction process 45 executable by a digital asset-based interaction computing entity 16 of a digital asset-based interaction system. FIG. 10 depicts a portion of the digital asset-based interaction system that includes a source computing entity 12, a destination computing entity 14, an interface means 18, a digital asset-based interaction computing entity 16, a digital asset backing computing entity 20, and one or more digital asset exchange computing entities 22.

The method of FIG. 10 is similar to the method of FIG. 8 except that at step 1, an acknowledgment (ACK) is generated when an amount of system digital assets is locked to back the digital asset-based interaction (e.g., the digital assets have not been received yet). For example, locking the system digital assets (a step that occurs during the concurrent nonreal-time digital asset-based interaction process) implies authorization of the digital asset-based interaction, and the digital asset-based interaction computing entity 16 allows a time period (e.g., up to five minutes) prior to obtaining digital assets from the source computing entity (e.g., the first computing entity has time to add tip, split payment with another user, adjust type of digital asset used, etc.).

The method continues at step 2, where the digital asset-based interaction computing entity 16 sends the ACK to the destination computing entity 14. For example, when the destination computing entity is a POS computing device such as an attended register, this ACK may successfully end the in-person transaction such that a merchant and customer can part ways. However, the destination computing entity receives the payment up to a few minutes later.

The method continues with step 3 where the source computing entity 12 directs an amount of digital assets 34 to the digital asset-based interaction computing entity 16 via the interface means 18. For example, the destination computing entity 14 provides the source computing entity 12 with a link (e.g., via a scannable code, a uniform resource locator (URL) link, etc.) to an address associated with the digital asset-based interaction computing entity 16. In this example, the source computing entity 12 is not associated with the digital asset-based interaction computing entity 16 so funds are pushed from the source computing entity 12 to the digital asset-based interaction computing entity 16. In another embodiment, when the source computing entity 12 is associated with the digital asset-based interaction computing entity 16 (e.g., the source computing entity 12 includes an asset management unit having a digital asset-based interaction interface), the digital asset-based interaction computing entity 16 is also operable to pull funds from the source computing entity 12 (e.g., the source computing entity 12 presents a code to the destination computing entity 14, the destination computing entity 14 scans the code to send information to the digital asset-based interaction computing entity 16, and the digital asset-based interaction computing entity 16 pulls funds from the source computing entity 12).

The method continues with step 4 where receipt of the amount of the digital assets is generated, and an authorization process begins. The authorization process will be discussed in more detail with reference to FIGS. 16-24.

When the authorization process is successful, the method continues with step 5 where the digital asset-based interaction computing entity 16 connects to one or more digital asset exchange entities 22 to exchange the amount of the digital assets 34 received from the source computing entity 12 to an amount of desired assets 60. Digital asset exchange is done quickly (e.g., 30 seconds to a few minutes) to account for exchange rate volatility. The exchange can also be performed immediately on a credit-based account to eliminate any pricing volatility.

The method continues with step 6 where the digital asset-based interaction computing entity 16 sends the amount of the desired assets 60 to the destination computing entity 14. For example, the digital asset-based interaction computing entity 16 sends the amount of the desired assets 60 to a banking computing entity associated with the destination computing entity 14. As another example, the digital asset-based interaction computing entity 16 directs the amount of the desired assets 60 to a wallet address associated with the destination computing entity 14.

FIGS. 11A-11C are flowcharts of an example of a method of a nonreal-time digital asset-based interaction process executable by a digital asset-based interaction computing entity of a digital asset-based interaction system. FIGS. 11A-11C depict a portion of the digital asset-based interaction system that includes a digital asset-based interaction computing entity 16, a digital asset backing computing entity 20, one or more staking computing entities 24, a transformer pool 26, and a digital asset distributed ledger technology (DLT) network 28.

The nonreal-time digital asset-based interaction process 47 of FIGS. 11A-11C begins concurrently with the real-time digital asset-based interaction process 45 of FIGS. 8-10. However, the nonreal-time digital asset-based interaction process 47 occurs over a longer period of time (e.g., minutes to hours) than the real-time digital asset-based interaction process 45 (e.g., seconds).

The method begins with FIG. 11A at step 1 where the digital asset-based interaction computing entity 16 instructs the digital asset backing computing entity 20 of the digital asset-based interaction system to lock an amount of system digital assets associated with a digital asset-based interaction. The digital asset-based interaction involves a source computing entity providing digital assets and a destination computing entity accepting desired assets. The destination computing entity is associated with the digital asset-based interaction computing entity.

The digital asset backing computing entity 20 may be a part of or separate from the digital asset-based interaction computing entity 16. The digital asset backing computing entity 20 manages the storage and use of system digital assets 62 (e.g., system cryptocurrency, system tokens, etc.) for collaterally backing digital asset-based interactions. System digital assets 62 are digital assets that serve as collateral to back digital asset-based interactions of the digital asset-based interaction system.

One or more staking computing entities 24 provide the digital asset backing computing entity 20 with system digital assets 62 and instructions on how to stake the system digital assets 62. In this example, the one or more staking computing entities 24 provided the digital asset backing computing entity 20 system digital assets 62 to back a digital asset DLT network 28 associated with the digital assets used by the source computing entity in the digital asset-based interaction. The digital asset backing computing entity 20 deposits system digital assets 62 in a transformer pool 26 associated with the digital asset DLT network 28 to back digital asset-based interactions associated with the digital asset DLT network 28. The transformer pool 26 is a smart contract that stores system digital assets 62 to back the digital asset DLT network 28. The one or more staking computing entities, the digital asset backing computing entity, and the transformer pool will be discussed in more detail with reference to FIGS. 12-15.

The method continues with step 2 where the digital asset backing computing entity 20 locks an amount of system digital assets 62 within the transformer pool 26 to back the digital asset-based interaction. A system acknowledgment (ACK) that the system digital assets have been locked may be generated. The ACK triggers a portion of the real-time digital asset-based interaction process (e.g., digital asset exchange can occur now that the system digital assets are locked, etc.) or can end an in-person transaction where the ACK serves as authorization of the digital asset-based interaction.

The amount of system digital assets locked may be based on a variety of factors such as the amount of the digital asset-based interaction (e.g., the amount of system digital assets is substantially equivalent to the amount of the digital asset-based interaction), the item involved in the digital asset-based interaction (e.g., the amount of system digital assets may be more than the amount of the digital asset-based interaction when certain types of goods, such as luxury goods, are involved), source computing entity information (e.g., if the source computing entity has a history of fraudulent interactions, the amount of system digital assets may be more than the amount of the digital asset-based interaction), destination computing entity information (e.g., merchant-based requirements, default settings), a type of digital asset-based interaction (e.g., authorization holds such as for hotel room purchase may require a larger amount of system digital assets than the amount of the digital asset-based interaction), digital asset backing computing entity 16 default settings, etc.

If the digital asset-based interaction initiation is terminated (e.g., interaction initiation fails and/or is cancelled by the source and/or the destination computing entity) or the digital asset-based interaction is not authorized during the authorization process within a certain amount of time prior to the digital asset-based interaction computing entity exchanging the digital asset to the desired asset format (e.g., step 3 of FIG. 8), the digital asset-based interaction computing entity instructs the digital asset backing computing entity to release the amount of locked system digital asset.

Step 2 of FIG. 11A may occur before, concurrently, or after obtaining digital assets from the source computing entity (but before exchanging digital assets for desired assets). If step 2 occurs before obtaining digital assets, an acknowledgement (ACK) may be generated. For example, locking the system digital assets implies authorization of the digital asset-based interaction, and the digital asset-based interaction computing entity 16 allows a time period (e.g., up to five minutes) prior to obtaining digital assets from the source computing entity (e.g., the first computing entity has time to add tip, split payment with another user, adjust type of digital asset used, etc.). The destination computing entity is provided a confirmation of this ACK. For example, when the destination computing entity is a POS computing device such as an attended register, this ACK may successfully end the in-person transaction such that a merchant and customer can part ways. However, the destination computing entity receives the payment up to a few minutes later.

When the digital asset backing computing entity 16 locks the system digital assets, a rate quote for the amount of digital assets used by the source computing entity is locked. An exchange rate is a price at which one digital asset will be exchanged for another. A rate quote is an exchange rate at a given point in time as determined by a digital asset exchange (e.g., cryptocurrency exchange) based on the buying and selling activity of the digital assets within the exchange.

The method continues with step 3 where the digital asset-based interaction computing entity 16 connects to the digital asset DLT network 28 associated with the digital assets 34 used by the source computing entity to verify obtaining the digital assets 34. The digital asset DLT network 28 implements a validation procedure that may take minutes to hours of time.

The method continues with FIG. 11B with step 4 where the amount of digital assets is verified. The method continues with step 5 where the digital asset-based interaction computing entity 16 instructs the digital asset backing computing entity 20 to release the amount of system digital assets associated with the digital asset-based interaction (e.g., locked system digital assets 64). The method continues with step 6 where the digital asset backing computing entity 20 releases the locked system digital assets 64.

Alternatively, the method continues with FIG. 11C with alternative step 4 where the amount of digital assets is not verified. For example, if fraudulent activity occurs (e.g., the source computing entity acts maliciously to spend the same funds at two merchants simultaneously, software of the asset management unit is corrupted, etc.) the digital asset-based interaction computing entity consumes at least a portion of the amount of system digital assets associated with the digital asset-based interaction (e.g., locked system digital assets 64). As a specific example, if the source computing entity attempts to double spend a transaction, the verification (e.g., the desired number of confirmations in a Bitcoin blockchain example) will not be received and the digital asset-based interaction computing entity will not be able to verify the amount of the digital asset received by the source computing entity.

The method continues with step 5 where the digital asset-based interaction computing entity 16 instructs the digital asset backing computing entity 20 to consume at least a portion of the amount of system digital assets associated with the digital asset-based interaction (e.g., locked system digital assets 64).

Consuming the amount of system digital asset means that (at step 6) the amount of system digital assets is transferred (e.g., via an on-chain transaction) from an address associated with the transformer pool 26 to an address associated with the digital asset-based interaction computing entity 16. When the amount of system digital assets is more than the amount of the digital asset-based interaction, only a portion of the amount of system digital assets (to cover the digital asset-based interaction) may be consumed while the remainder is unlocked. In another example, regardless of whether the amount of system digital assets is more than the amount of the digital asset-based interaction, the entire amount of the of system digital assets may be consumed.

FIG. 12 is a schematic block diagram of an embodiment of a portion of a digital asset-based interaction system 10 that includes a digital asset backing computing entity 20, one or more staking computing entities 24, transformer pool 26-1 through 26-2, stake pool 27, digital asset distributed ledger technology (DLT) networks 28-1 through 28-2, and a custodial digital asset management unit 29.

The digital asset backing computing entity 20 manages the storage and use of system digital assets (e.g., system cryptocurrency, system tokens, etc.) for collaterally backing digital asset-based interactions and may be a part of or separate from the digital asset-based interaction computing entity 16. The digital asset backing computing entity 20 interacts with the one or more staking computing entities 24. The one or more staking computing entities 24 provide the digital asset backing computing entity 20 with system digital assets (deposits/withdrawals 68) and instructions on how to stake the system digital assets (staking instructions 66).

The one or more staking computing entities 24 may be one or more user computing devices, one or more merchant computing entities, a digital asset management computing entity associated with an asset management unit, one or more computing entities associated with a corporation and/or business, etc. The one or more staking computing entities 24 (e.g., a user computing device, etc.) are associated with the digital asset backing computing entity 20 via an account (e.g., a stake account).

System digital assets are digital assets that serve as collateral to back digital asset-based interactions of the digital asset-based interaction system. The system digital assets may be any digital asset that the digital asset-based interaction system chooses to use. For example, the system digital asset is a token on the Ethereum blockchain specifically created for use in the digital asset-based interaction system. As another example, the system digital asset is an already established and trusted cryptocurrency. The digital asset backing computing entity 20 also manages information associated with the one or more staking computing entities 24 such as identifying information of the one or more staking computing entities 24, system digital asset balances and availability, rewards calculations, etc.

The digital asset DLT networks 28-1 through 28-2 are digital systems associated with a particular digital asset. A digital asset DLT network includes a plurality of consensus network computing entity nodes operable to implement a validation procedure to verify the authenticity of transactions recorded on a distributed ledger. For example, the validation procedure is a consensus method. Examples of consensus methods include proof-of-work, proof-of-stake, Practical Byzantine Fault Tolerance (PBFT), and Directed Acyclic Graph (DAG). The plurality of consensus computing entity nodes executes the validation procedure to validate and broadcast transactions to the distributed ledger stored by each consensus network computing entity node of the plurality of consensus network computing entity nodes.

For example, the DLT network 28-1 may be the Ethereum network and the particular digital asset it is associated with is Ether. As another example, the DLT network 28-2 may be the Bitcoin network and the particular digital asset it is associated with is Bitcoin.

The custodial asset management unit 29 may be a custodial digital wallet application associated with a digital asset management computing entity that may be specially licensed and insured to hold digital assets (e.g., a digital asset holding and management company, a cryptocurrency holding company, a cryptocurrency holding and exchange company, etc.). The digital asset management computing entity (i.e., “the custodian”) of a custodial digital wallet application holds the private key needed to gain access to digital assets.

In this example, the one or more the staking computing entities 24 provide the digital asset backing computing entity 20 with system digital assets (e.g., deposits/withdrawals 68) and staking instructions 66. The staking instructions 66 include instructions to stake an amount of system digital assets 70-1 to back the digital asset DLT network 28-1 (e.g., the Ethereum network), instructions to stake an amount of system digital assets 70-2 to back the digital asset DLT network 28-2 (e.g., the Bitcoin network), and instructions to stake an amount of system digital assets 70-3 to back a custodial asset management unit 29. The digital asset backing computing entity 20 keeps track of the amounts of system digital assets each staking computing entity 24 of the one or more staking computing entities 24 is contributing/depositing via each staking computing entity's account.

Backing the digital asset DLT networks 28-1 and 29-2 means that a consensus network computing entity node 25-1_1 of the digital asset DLT network 28-1 is backed to ensure transactions are written onto the ledger and a consensus network computing entity node 25-2_1 of the digital asset DLT network 28-2 is backed to ensure transactions are written onto the ledger. The consensus network computing entity nodes 25-1_1 and 25-2_1 may be associated with the digital asset-based interaction computing entity 16. Backing a particular consensus network computing entity node of the digital asset DLT network 28 is necessary for backing digital asset-based interactions involving digital assets stored in a non-custodial asset management unit not associated with the digital asset-based interaction computing entity 16 because the non-custodial asset management unit is interfacing directly with the digital asset DLT network when initiating digital asset-based interactions. When a digital asset-based interaction involves digital assets stored in a custodial asset management unit, the custodial asset management unit (such as custodial asset management unit 29) is backed rather than a particular consensus network computing entity node of the digital asset DLT network because the custodian (e.g., a digital asset management computing entity) interacts with the digital asset DLT network on behalf of the custodial asset management unit.

Based on the staking instructions 66, the digital asset backing computing entity 20 deposits the amount of the system digital assets 70-1 into transformer pool 26-1 where transformer pool 26-1 is associated with the consensus network computing entity node 25-1_1 of the digital asset DLT network 28-1, deposits the amount of the system digital assets 70-2 into transformer pool 26-2 where transformer pool 26-2 is associated with the consensus network computing entity node 25-2_1 of the digital asset DLT network 28-2, and deposits the amount of the system digital assets 70-3 into the stake pool 27 where the stake pool 27 is associated with the custodial asset management unit 29.

The transformer pools 26-1 through 26-2 and the stake pool 27 are smart contracts (e.g., Ethereum smart contracts) that store system digital assets to back digital asset DLT networks 28-1 through 28-2 and the custodial asset management unit 29. For example, the transformer pool 26-1 stores system digital assets 62-1 for backing digital asset DLT network 28-1 digital asset-based interactions (e.g., digital asset-based interactions involving Ether when the digital asset DLT network 28-1 is the Ethereum network), the transformer pool 26-2 stores system digital assets 62-2 for backing digital asset DLT network 28-2 digital asset-based interactions (e.g., digital asset-based interactions involving Bitcoin when the digital asset DLT network 28-2 is the Bitcoin network), and the stake pool 27 stores system digital assets 62-3 for custodial asset management unit 29 digital asset-based interactions.

With digital asset DLT networks backed by system digital assets, users (e.g., source computing entities) can provide digital assets associated with those backed digital asset DLT networks for digital asset-based interactions from any digital wallet application (e.g., asset management unit) of their choosing. In other words, a user does not need to be associated with the digital asset-based interaction system (e.g., use an asset management unit that is staked and therefore associated with the digital asset-based interaction computing entity) to partake in digital asset-based interactions facilitated by the digital asset-based interaction system.

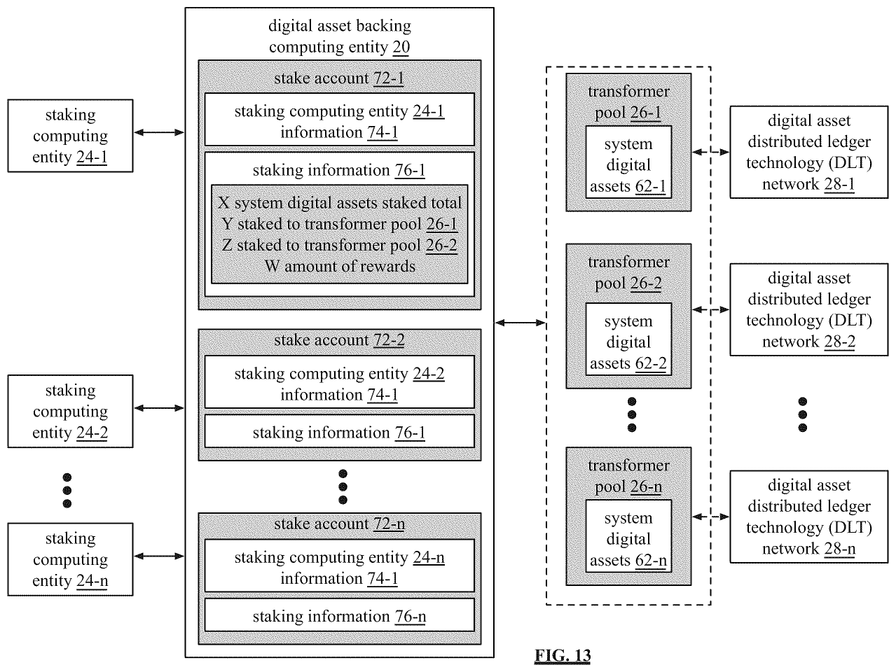

FIG. 13 is a schematic block diagram of an embodiment of a portion of a digital asset-based interaction system that includes a digital asset backing computing entity 20, a plurality of staking computing entities 24-1 through 24-n, a plurality of transformer pools 26-1 through 26-n, and a plurality of digital asset distributed ledger technology (DLT) networks 28-1 through 28-n.

The transformer pools 26-1 through 26-n are smart contracts (e.g., Ethereum smart contracts) that store system digital assets 62-1 through 62-n to back digital asset DLT networks 28-1 through 28-n. For example, the transformer pool 26-1 stores system digital assets 62-1 for backing digital asset DLT network 28-1 digital asset-based interactions, the transformer pool 26-2 stores system digital assets 62-2 for backing digital asset DLT network 28-2 digital asset-based interactions, and the transformer pool 26-n stores system digital assets 62-n for backing digital asset DLT network 28-n digital asset-based interactions.

The plurality of staking computing entities 24-1 through 24-n are associated with the digital asset backing computing entity 20 via stake accounts 72-1 through 72-n. The stake accounts 72-1 through 72-n include staking computing entity information 74-1 through 74-n and staking information 76-1 through 76-n. The staking computing entity information 74-1 through 74-n includes identifying information of the staking computing entities 24-1 through 24-n such as a user identifier (ID), a password, a name, email address, etc. The staking computing entity information 74-1 through 74-n may also include other personal information such as a physical address, personal account preferences, historical user data, etc.

The staking information 76-1 through 76-n includes information pertaining to the amount of system digital assets staked and the location of the staking. The staking information 76-1 through 76-n may also include reward information, recent activity (e.g., an event log), information pertaining to staking locations (e.g., network activity), etc. For example, the staking information 76-1 of stake account 72-1 shows that the staking computing entity 24-1 has deposited and staked X system digital assets total: Y system digital assets have been staked to transformer pool 26-1 to back digital asset DLT network 28-1 digital asset-based interactions and X system digital assets have been staked to transformer pool 26-2 to back digital asset DLT network 28-2 digital asset-based interactions (where Y+Z=X). The staking information 76-1 also includes a rewards balance of W rewards. Rewards are system digital assets earned from successful digital asset-based interactions made that were at least partially staked by the staking entity.

For example, if the digital asset DLT network 28-1 is the Ethereum network, a successful digital asset-based interaction involving Ether would result in a transaction fee for that digital asset-based interaction being added to the transformer pool 26-1 as rewards. Rewards distribution may be based on the amount of system digital assets provided, the type of staking computing entity involved, a contractual agreement, etc.

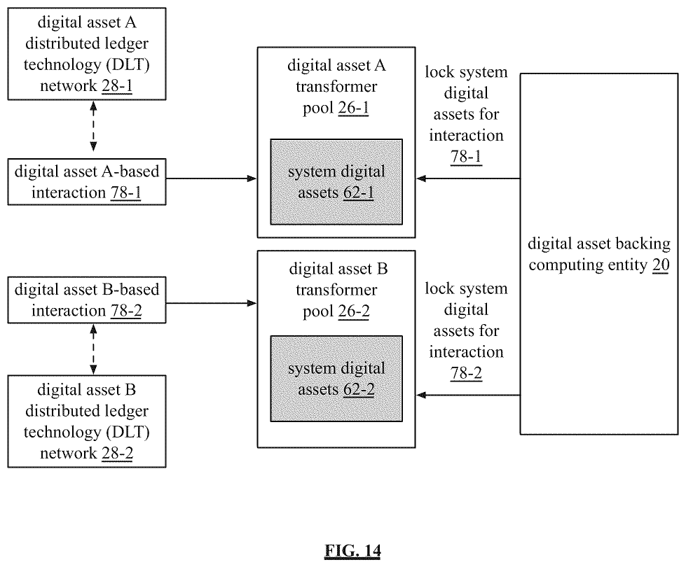

FIG. 14 is a schematic block diagram of an embodiment of a portion of a digital asset-based interaction system that includes a digital asset backing computing entity 20, a digital asset A transformer pool 26-1, a digital asset B transformer pool 26-2, a digital asset A digital asset distributed ledger technology (DLT) network 28-1, and a digital asset B DLT network 28-2.

The digital asset A DLT network 28-1 is a digital system associated with digital assets A. The digital asset B DLT network 28-2 is a digital system associated with digital assets B. A digital asset DLT network includes a plurality of consensus network computing entity nodes operable to implement a validation procedure to verify the authenticity of transactions recorded on a distributed ledger.

The digital asset A transformer pool 26-1 and the digital asset B transformer pool 26-2 are smart contracts (e.g., Ethereum smart contracts) that store system digital assets 62-1 and 62-2 to back digital asset A DLT networks 28-1 and digital asset B DLT networks 28-2. For example, the digital asset A transformer pool 26-1 stores system digital assets 62-1 for backing digital asset A DLT network 28-1 digital asset-based interactions and the digital asset B transformer pool 26-2 stores system digital assets 62-2 for backing digital asset B DLT network 28-2 digital asset-based interactions.

In this example, two digital asset-based interactions have been initiated, a digital asset A-based interaction 78-1 and a digital asset B-based interaction 78-2. For example, a first source computing entity initiated a digital asset A-based interaction 78-1 to provide an amount of digital assets A where a first destination computing entity accepts first desired assets and a second source computing entity initiated a digital asset B-based interaction 78-2 to provide an amount of digital assets B where a second destination computing entity accepts second desired assets. In another example, the first source computing entity initiates both the digital asset A-based interaction 78-1 and the digital asset B-based interaction 78-2 with one or more destination computing entities.

Because the digital asset A-based interaction 78-1 involves digital assets A, the digital asset A-based interaction 78-1 is associated with the digital asset A DLT network 28-1. For example, sending the amount of the digital assets A to the digital asset-based interaction computing entity would be a transaction added to the digital asset A DLT network 28-1 (e.g., a transaction added to a block when the digital asset A DLT network is a blockchain). Likewise, because the digital asset B-based interaction 78-2 involves digital assets B, the digital asset B-based interaction 78-2 is associated with the digital asset B DLT network 28-2. For example, sending the amount of the digital assets B to the digital asset-based interaction computing entity would be a transaction added to the digital asset B DLT network 28-2 (e.g., a transaction added to a block when the digital asset B DLT network 28-2 is a blockchain).

To back the digital asset A-based interaction 78-1, the digital asset backing computing entity 20 locks an amount of system digital assets stored in the digital asset A transformer pool 26-1. To back the digital asset B-based interaction 78-2, the digital asset backing computing entity 20 locks an amount of system digital assets stored in the digital asset B transformer pool 26-2.

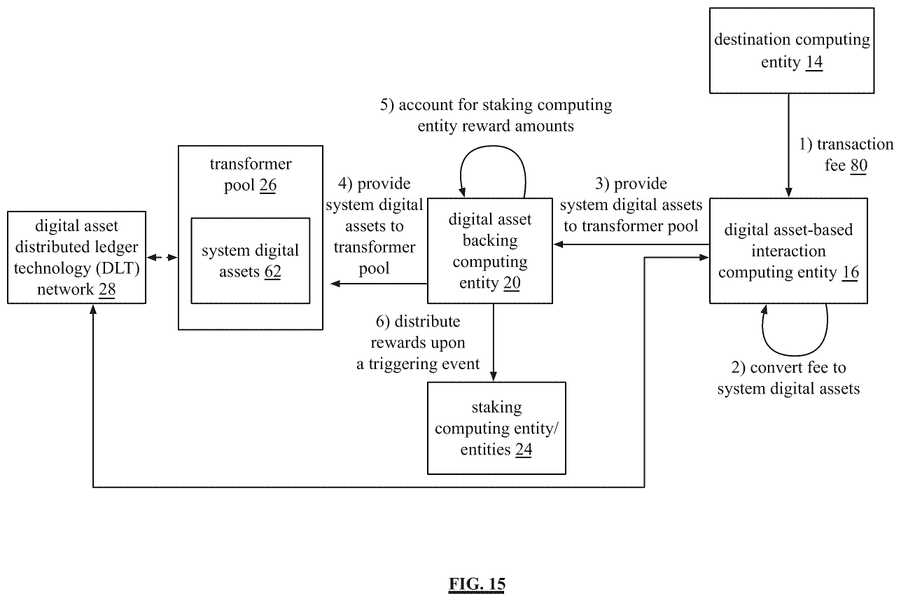

FIG. 15 is a flowchart of an example of a method of distributing system digital assets as rewards. FIG. 15 depicts a portion of a digital asset-based interaction system that includes a destination computing entity 14, a digital asset-based interaction computing entity 16, a digital asset backing computing entity 20, one or more staking computing entities 24, a transformer pool 26, and a digital asset distributed ledger technology (DLT) networks 28.

The method begins with step 1, where after a successful digital asset-based interaction, the destination computing entity 14 provides a transaction fee 80 to the digital asset-based interaction computing entity 16. A successful digital asset-based interaction from the destination computing entity's perspective means that the real-time digital asset-based interaction process occurred successfully and the destination computing entity 14 received the desired assets.

The method continues with step 2 where the digital asset-based interaction computing entity 16 converts the transaction fee 80 to system digital assets if needed (e.g., via the one or more exchange computing entities). In another example, the destination computing entity 14 may provide system digital assets for transaction fees (e.g., the destination computing entity 14 has an account for storing system digital assets to be used for transaction fees).

The method continues with step 3 where the digital asset-based interaction computing entity 16 sends an instruction to the digital asset backing computing entity 20 to provide the system digital assets to the appropriate transformer pool 26. For example, the successful digital asset-based interaction involved a digital asset associated with the digital asset DLT network 28 that was backed by system digital assets 62 stored in the transformer pool 26. Therefore, the system digital asset rewards would go to the transformer pool 26 as shown.

The method continues with step 4 where the digital asset backing computing entity 20 provides the system digital assets to the transformer pool 62. The method continues with step 5 where the digital asset backing computing entity 20 accounts for staking computing entity reward amounts. For example, the digital asset backing computing entity 20 updates the accounts associated with the one or more staking computing entities 24 that provided the system digital assets 62 to back the digital asset DLT network 28 to reflect this new reward. For example, a first staking computing entity may get a first fraction of the system digital assets reward and a second staking computing entity may get a second fraction of the system digital assets reward. The fractions of the system digital assets reward distributed to each staking computing entity depends on how much system digital assets the one or more staking computing entities have staked, a contractual agreement, the type of staking computing entity, how long the staking computing entity has kept system digital assets staked, etc.

The method continues with step 6 where the digital asset backing computing entity 20 distributes rewards to the one or more staking computing entities 24 upon a triggering event. The triggering event may be a withdrawal request, a time period, a successful digital asset-based interaction (i.e., an immediate deposit), etc. In another example, the digital asset backing computing entity 20 calculates the reward amounts upon the triggering event. The rewards distributions may be batched and published using a zero-knowledge proof such that the staking computing entities can verify that their rewards amounts are correct but the reward amounts themselves are not make public.

In another embodiment, the digital asset-based interaction system may be a transaction fee-less system that still produces rewards for staking computing entities as incentives for staking. For example, the digital asset-based interaction computing entity 16 deposits stored system digital assets with an interest generating computing entity and the interest generated is at least partially distributed back to the staking computing entities as rewards.

FIG. 16 is schematic block diagram of an embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, at least one transformer pool 26, and at least one digital asset distributed ledger technology (DLT) network 28.

The digital asset-based interaction system 10 of FIG. 16 operates similarly to the digital asset-based interaction system 10 of FIG. 1 except that the digital asset-based interaction computing entity 16 is shown including a digital asset-based interaction authorization module 82.

By staking the digital asset DLT network 28 associated with the digital assets 34 to allow source computing entities to use any asset management unit of their choosing for providing digital assets 34, the asset management units and source computing entities may not be associated with the digital asset-based interaction system 10 and could introduce fraud, risk, and errors to the system. To mitigate these issues, upon obtaining digital asset-based interaction information and/or digital assets for a digital asset-based interaction, the digital asset-based interaction authorization module 82 is operable to authorize the digital asset-based interaction by performing an authorization process. The authorization process involves comparing characteristics of the digital asset-based interaction with system authorization parameters related to the digital asset-based interaction to detect errors and/or fraudulent activity associated with the digital asset-based interaction.

The authorization process may occur at different times in the digital asset-based interaction (before or after the system digital assets are locked but before the digital assets are exchanged for desired assets). For example, the authorization process occurs when the digital assets are received by the digital asset-based interaction computing entity 16 and the system digital assets are locked by the digital asset backing computing entity 20 (as discussed with reference to FIGS. 8 and 10). As another example, the authorization process occurs when the digital assets are received by the digital asset-based interaction computing entity 16 and the system digital assets are not locked yet by the digital asset backing computing entity 20 (as discussed with reference to FIG. 9).

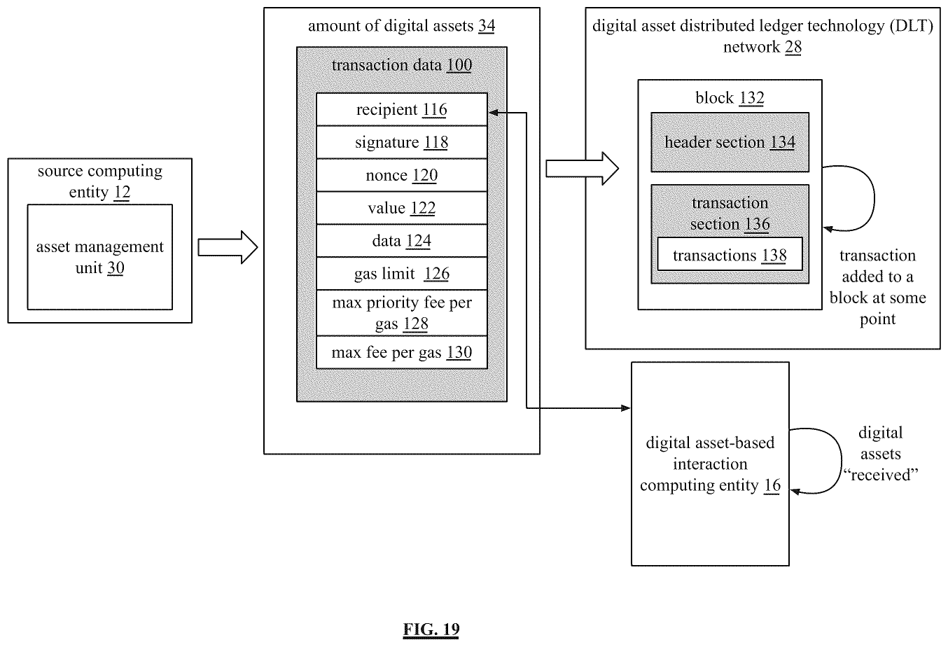

The characteristics of the digital asset-based interaction include the digital asset-based interaction information (e.g., source computing entity information, destination computing entity information, item(s) involved in the digital asset-based interaction, the amount of the digital asset-based interaction, digital asset-based interaction metadata, etc.) and transaction data pertaining to the source computing entity sending digital assets to the digital asset-based interaction computing entity 16. The transaction data will be discussed in more detail with reference to FIG. 19.

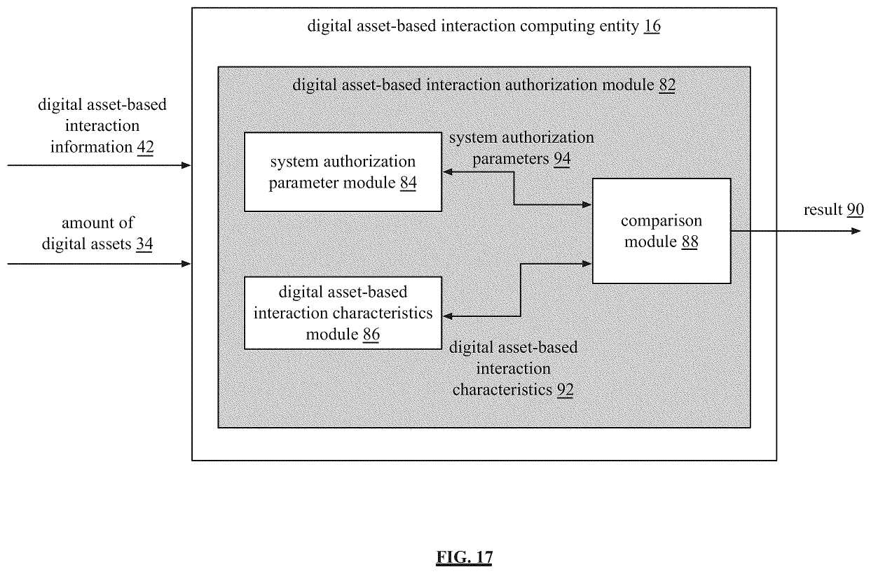

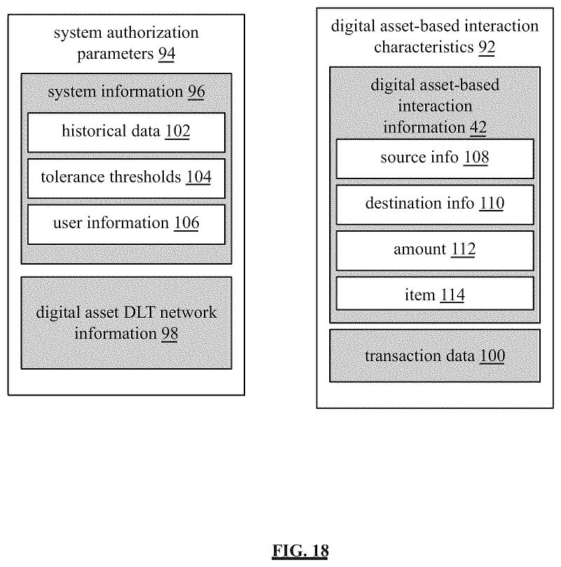

The system authorization parameters include system information (e.g., digital asset-based interaction historical data, tolerance thresholds, user information, etc.) and digital asset DLT network information. The digital asset DLT network information may include any information of interest related to a particular digital asset DLT network. For example, the digital asset DLT network information may include price history of the digital assets, market capitalization, block information (e.g., when the digital asset DLT network is a blockchain), circulating supply of the digital assets, a maximum supply, the validation procedure used (e.g., a consensus method such as proof of work or proof of stake), algorithms used, transaction data, validation procedure timing information (e.g., average confirmation time), mempool (e.g., a temporary storage area for transactions, a “memory pool”) information, transaction fees, validator rewards (e.g., a block reward), etc. The system authorization parameters will be discussed in more detail with reference to FIGS. 17-18.

FIG. 17 is a schematic block diagram of an embodiment of a digital asset-based interaction computing entity 16 that includes a digital asset-based interaction authorization module 82. The digital asset-based interaction authorization module 82 includes a system authorization parameter module 84, a digital asset-based interaction characteristics module 86, and a comparison module 88.

In this example, a digital asset-based interaction has been initiated (e.g., the digital asset-based interaction computing entity 16 has obtained the digital asset-based interaction information 42) and the digital asset-based interaction computing entity 16 has obtained an amount of digital assets 34 from a source computing entity for the digital asset-based interaction. To mitigate potential errors and risk, upon obtaining digital asset-based interaction information and/or digital assets for a digital asset-based interaction, the digital asset-based interaction authorization module 82 is operable to authorize the digital asset-based interaction.

The system authorization parameter module 84 stores, gathers, organizes, determines, etc., system authorization parameters 94. The system authorization parameters 94 include system information and digital asset distributed ledger technology (DLT) network information. The system information includes historical data, user information, and/or system tolerance thresholds. The digital asset DLT network information includes information of interest related to a particular digital asset DLT network. For example, the digital asset DLT network information may include price history of the digital assets, market capitalization, block information (e.g., when the digital asset DLT network is a blockchain), circulating supply of the digital assets, a maximum supply, the validation procedure used (e.g., a consensus algorithm such as proof of work or proof of stake), algorithms used, transaction data, validation procedure timing information (e.g., average confirmation time), mempool (e.g., a temporary storage area for transactions, a “memory pool”) information, transaction fees, validator rewards (e.g., a block reward), etc.

The system authorization parameters 94 may be generated based on a digital asset-based interaction to digital asset-based interaction basis and/or pre-generated. For example, for a digital asset-based interaction involving a digital asset A, the system authorization parameter module 84 may connect to a digital asset A DLT network to obtain digital asset A DLT network information as system authorization parameters. In another example, the system authorization parameter module 84 may periodically connect to digital asset A DLT network and store digital asset A DLT network information as system authorization parameters 94.

As another example, the system authorization parameter module 84 may store historical data in a lookup table and upon a new digital asset-based interaction, will look up the appropriate data (e.g., historical data related to a particular source computing entity, etc.) from the lookup table to include as system authorization parameters 94.

The digital asset-based interaction characteristics module 86 stores, gathers, organizes, determines, etc., characteristics of an incoming digital asset-based interaction (e.g., digital asset-based interaction characteristics 92). The digital asset-based interaction characteristics 92 include the digital asset-based interaction information 42 (e.g., source computing entity information, destination computing entity information, item(s) involved in the digital asset-based interaction, the amount of the digital asset-based interaction, digital asset-based interaction metadata, etc.) and transaction data pertaining to the source computing entity sending digital assets to the digital asset-based interaction computing entity 16 (e.g., the amount of digital assets 34).

The information contained in the transaction data depends on the type of digital asset and digital asset DLT network involved. Transaction data will be discussed in more detail with reference to FIG. 19. After a digital asset-based interaction authorization, the digital asset-based interaction characteristics module 86 may transfer digital asset-based interaction characteristics 92 to the system authorization parameter module 84 to be stored as historical data.

The comparison module 88 compares system authorization parameters 94 provided by the system authorization parameter module 84 with the digital asset-based interaction characteristics 92 provided by the digital asset-based interaction characteristics module 86 to determine a result 90. When the system authorization parameters 94 compare favorably to the digital asset-based interaction characteristics 92, the result 90 is an authorized result. The system authorization parameters 94 may compare favorably to the digital asset-based interaction characteristics 92 when they are within a system tolerance threshold, when they are substantially equal, etc.

When the system authorization parameters 94 do not compare favorably to the digital asset-based interaction characteristics 92, the result 90 is a non-authorized result. The system authorization parameters 94 may not compare favorably to the digital asset-based interaction characteristics 92 when they are not within a system tolerance threshold, when they are not substantially equal, etc. When the result 90 is a non-authorized result, the digital asset-based interaction authorization module 82 may present remedy options to the source computing entity to correct a particular issue and/or retry the digital asset-based interaction. Alternatively, when the result 90 is a non-authorized result, the digital asset-based interaction authorization module 82 may terminate the digital asset-based interaction.

FIG. 18 is a schematic block diagram of an example of system authorization parameters 94 and digital asset-based interaction characteristics 92 generated, organized, and/or stored by a digital asset-based interaction authorization module 82 of a digital asset-based interaction computing entity for use in an authorization process. The authorization process is described in more detail with reference to FIGS. 16-17 and 19-24.

The system authorization parameters 94 include system information 96 and digital asset DLT network information 98. The system information 96 includes historical data 102, system tolerance thresholds 104, and user information 106. Historical data 102 may include past digital asset-based interaction information such as the information pertaining to the parties involved (e.g., source computing entity identifiers (IDs), destination computing entity identifiers (IDs), merchant information, etc.), digital asset-based interaction amounts, whether or not a digital asset-based interaction was successful, etc., as well as historical authorization information such as a list of users associated with unauthorized digital asset-based interactions and/or suspicious activity.

Suspicious activity could include errors (e.g., the amount of digital assets sent is less than or more than the amount owed for the digital asset-based interaction), transaction fee issues (e.g., a transaction fee is too low which could be an indication of potential fraud), repeated digital asset-based interaction terminations (e.g., the user has a history of manipulating digital asset-based interactions), etc.

The system tolerance thresholds 104 include ranges of tolerance to use in comparison situations. The system tolerance thresholds 104 may be stored/generated as system information and provided to the comparison module to use in comparisons. For example, certain digital asset-based interaction characteristics may be compared with each other in accordance with a system tolerance threshold 104. For example, a system tolerance threshold for the amount of the digital asset-based interaction may be 0%. For example, if the source computing entity sends an amount of digital assets that is not equal to the amount of the digital assets in the digital asset-based interaction as identified in the digital asset-based interaction information 42 (e.g., it is too low or too high), the digital asset-based interaction may not be authorized.

User information 106 includes identifying information of parties involved in past and/or current digital asset-based interactions as well as any personal information such as email address, username, password, physical address, loyalty information, etc. Historical user information may be stored with the historical data 102. In an example, a source computing entity may provide a username and password as identifying information while initiating a digital asset-based interaction. This username and password (e.g., digital asset-based interaction characteristics) will be cross referenced with username and password combinations stored in the user information 106 (e.g., system authorization parameters) for errors and/or issues (e.g., the source computing entity may enter the wrong password associated with its source identifier (ID)).

The digital asset DLT network 98 information includes any information of interest related to a particular digital asset DLT network. For example, the digital asset DLT network information may include price history of the digital assets, market capitalization, block information (e.g., when the digital asset DLT network is a blockchain), circulating supply of the digital assets, a maximum supply, the validation procedure used (e.g., a consensus method such as proof of work or proof of stake), algorithms used, transaction data, validation procedure timing information (e.g., average confirmation time), mempool (e.g., a temporary storage area for transactions, a “memory pool”) information, transaction fees, validator rewards (e.g., a block reward), etc.

The system authorization parameters 94 may be generated based on a digital asset-based interaction to digital asset-based interaction basis and/or pre-generated. For example, for a digital asset-based interaction involving a digital asset A, the system authorization parameter module 84 may connect to a digital asset A DLT network to obtain digital asset A DLT network information as system authorization parameters 94. In another example, the system authorization parameter module may periodically connect to digital asset A DLT network and store digital asset A DLT network information as system authorization parameters 94.

The characteristics of an incoming digital asset-based interaction (digital asset-based interaction characteristics 92) include digital asset-based interaction information 42 and transaction data 100 pertaining to the source computing entity sending digital assets to the digital asset-based interaction computing entity (e.g., the amount of digital assets).

The digital asset-based interaction information 42 includes source computing entity information (e.g., source info 108), destination computing entity information (e.g., destination info 108), the amount of the digital asset-based interaction 112, and/or item(s) 114 involved in the digital asset-based interaction. The digital asset-based interaction information 42 may further include digital asset-based interaction metadata such as loyalty information, shipping details, etc.

The information contained in the transaction data 100 depends on the type of digital asset and digital asset DLT network involved. Transaction data will be discussed in more detail with reference to FIG. 19.

FIG. 19 is a schematic block diagram of an embodiment of a portion of a digital asset-based interaction system that includes a source computing entity 12, a digital asset-based interaction computing entity 16, and a digital asset distributed ledger technology (DLT) network 28. FIG. 19 depicts an example of the source computing entity 12 directing an amount of digital assets 34 to the digital asset-based interaction computing entity 16 to execute a digital asset-based interaction. The amount of digital assets 34 are associated with a digital asset DLT network 28. In this example, the digital asset DLT network 28 is a blockchain such as the Ethereum network.

Sending the amount of digital assets 34 to the digital asset-based interaction computing entity 16 is a transaction added to the digital asset DLT network 28. Transactions are cryptographically signed instructions from accounts. An account is the keypair for a user-owned account. A wallet application such as an asset management unit allows a user to interact with an account. The transaction includes transaction data 100 and this transaction data 100 is included as digital asset-based interaction characteristics used in the authorization process.

In this example, the transaction data 100 is modeled after an Ethereum transaction but the transaction data 100 could include more or less data fields than what is shown depending on the digital asset DLT network and digital assets involved. In this example, the transaction data 100 includes a recipient 116, signature 118, nonce 120, value 122, data 124, gas limit 126, max priority fee per gas 128, and a max fee per gas 130. The recipient 116 is the receiving address for the amount of the digital assets 34 (e.g., the digital asset-based interaction computing entity 16's address).

The signature 118 is the identifier of the sender (e.g., the source computing entity 12) that confirms the sender has authorized the transaction. It is generated when the sender's private key signs the transaction. The nonce 120 is a sequentially incrementing counter which indicates the transaction number from the account. The value 122 is the amount of the digital assets 34 to transfer from the source computing entity 12 to the digital asset-based interaction computing entity 16. The data 124 field is an optional field to include arbitrary data. The gas limit 126 is the max amount of gas units that can be consumed by a transaction. Gas is a reference to the computation required to process the transaction that users have to pay for. The max priority fee per gas 128 is the maximum amount of gas to be included as a tip to the validator (e.g., the node that adds transactions to a block), and a max fee per gas 130 is the maximum amount of gas willing to be paid for the transaction.

The transaction data 100 may include more or less fields but typically includes at least a signature (e.g., a private key to sign the transaction), an output (e.g., a destination for the funds), an amount (e.g., the amount involved in the transaction), and a transaction fee.

On the Ethereum network, for a new transaction to be included in the blockchain, it needs to be broadcast to the whole network. The transaction is included in a pool with lots of other transactions. A validator includes the transaction in a block in order to verify the transaction and consider it confirmed. As time passes, the block containing the transactions will be upgraded to finalized. Similarly, on the Bitcoin network, for a new transaction to be included in the blockchain, it is broadcasted to a node. The transaction waits in a mempool (e.g., a temporary storage area for transactions, a “memory pool”) until it is picked up by a Bitcoin miner and inserted into a block. The transactions with the highest fees are more likely to be included in the next block. As such, transaction fees can reflect the speed a user wants a transaction verified on the blockchain. To speed up a transaction, a user can offer a higher fee.

When the sending the amount of digital assets 34 from the source computing entity 12 to the digital asset-based interaction computing entity 16 transaction is added to the digital asset DLT network 28, the digital asset-based interaction computing entity 16 considers the amount of digital assets 34 “received.” However, the transaction has not yet been added to a block 132 for verification (the speed of which depends on the transaction fee).

The block 132 includes a header section 134 and a transaction section 136. In an Ethereum block, the header section 134 includes data fields such as a block number or slot the block belongs to, the identifier (ID) of the validator proposing the block, the hash of the preceding block, the root hash of the state object, a timestamp, a block difficulty, a nonce, etc. The transaction section 136 or body of the block primarily consists of a list of transactions 138. When the amount of digital assets 34 transaction is added to the block 132 in transactions 138, the validation procedure begins.

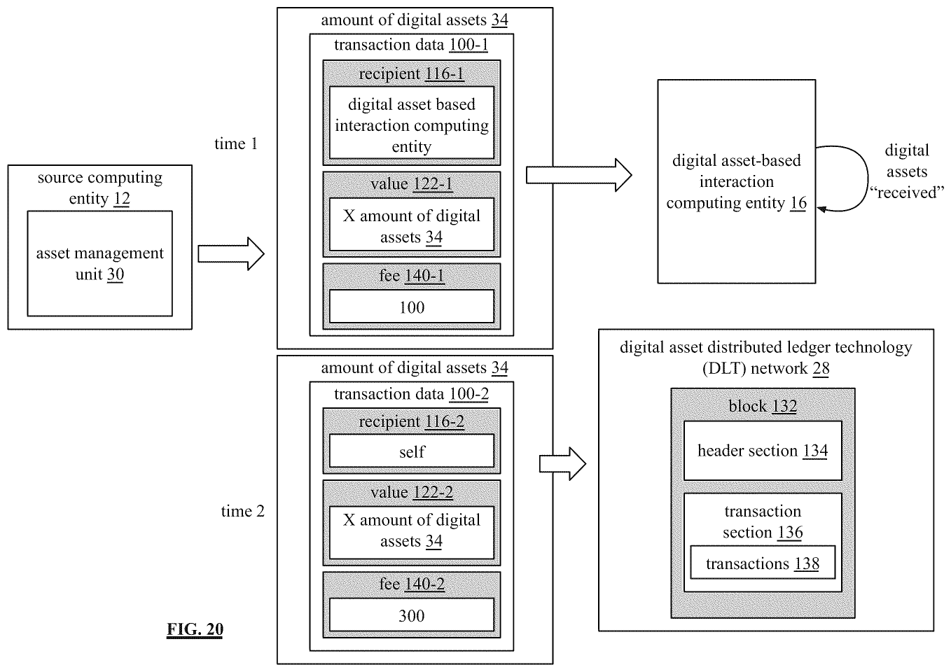

FIG. 20 is a schematic block diagram of an embodiment of a portion of a digital asset-based interaction system that includes a source computing entity 12, a digital asset-based interaction computing entity 16, and a digital asset distributed ledger technology (DLT) network 28. FIG. 20 depicts an example of the source computing entity 12 directing an amount of digital assets 34 to the digital asset-based interaction computing entity 16 at a first time (e.g., time 1) to execute a digital asset-based interaction. The amount of digital assets 34 are associated with a digital asset DLT network 28. In this example, the digital asset DLT network 28 is a blockchain such as the Ethereum network.

Sending the amount of digital assets 34 to the digital asset-based interaction computing entity 16 is a transaction added to the digital asset DLT network 28. The transaction includes a portion of transaction data 100-1. In this example, the portion of the transaction data 100-1 is modeled after an Ethereum transaction (similar to the example shown in FIG. 19) but the transaction data 100-1 could include more or less data fields than what is shown depending on the digital asset DLT network and digital assets involved.

The portion of the transaction data 100-1 shows that the recipient 116-1 is the digital asset-based interaction computing entity, the value 122-1 is X amount of digital assets 34 and the fee 140-1 for the computational effort of confirming the transaction is 100. At the time 1, the digital asset-based interaction computing entity 16 proceeds with the digital asset-based interaction as is considers the amount of digital assets have been received.

In an example of a bad actor source computing entity 12, the source computing entity at a time 2 shortly after time 1 attempts to replace the funds just sent to the digital asset-based interaction computing entity 16 by executing another transaction that includes a portion of transaction data 100-2. In this example, the portion of the transaction data 100-2 is modeled after an Ethereum transaction (similar to the example shown in FIG. 19) but the transaction data 100-2 could include more or less data fields than what is shown depending on the digital asset DLT network and digital assets involved. The portion of the transaction data 100-2 shows the recipient is self (e.g., the source computing entity), the value 122-2 is the X amount of digital assets 34, and the fee 140-2 is 300. The source computing entity 12 sets the fee 140-2 higher in the time 2 transaction than in the time 1 transaction so that it is added to the block 132 first.

If the fee 140-1 is too low, the time 1 transaction may not be added to a block or it may take a long period of time for it to be added to a block. Therefore, the time 1 transaction may never be validated by the digital asset DLT network 28 and the X amount of digital assets 34 will not be verified as being sent to the digital asset-based interaction computing entity 16 even though the digital asset-based interaction computing entity 16 carried on with the digital asset-based interaction. In that example, system digital assets would be used to cover the unverified digital assets sent by the bad actor source computing entity 12. To prevent this type of fraudulent activity, the digital asset-based interaction authorization module of the digital asset-based interaction computing entity 16 looks at the transaction data such as the transaction fee to identify red flags such as a transaction fee that is set too low.

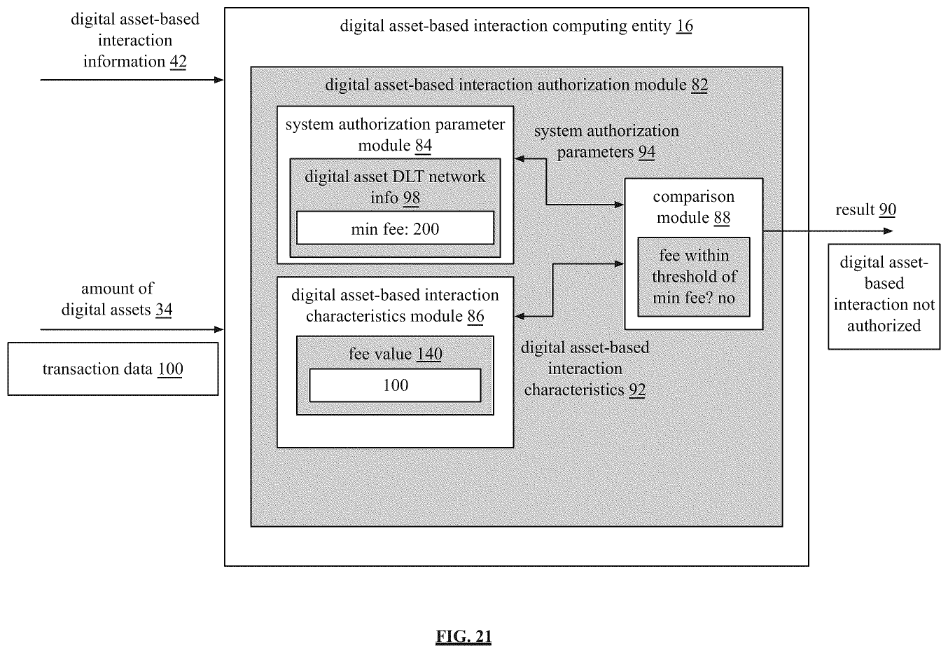

FIG. 21 is a schematic block diagram of an embodiment of a digital asset-based interaction computing entity 16 that includes a digital asset-based interaction authorization module 82. The digital asset-based interaction authorization module 82 includes a system authorization parameter module 84, a digital asset-based interaction characteristics module 86, and a comparison module 88.

In this example, a digital asset-based interaction has been initiated (e.g., the digital asset-based interaction computing entity 16 has obtained the digital asset-based interaction information 42) and the digital asset-based interaction computing entity 16 has obtained an amount of digital assets 34 from a source computing entity for the digital asset-based interaction. The amount of digital assets 34 received from the source computing entity is a transaction added to the digital asset distributed ledger technology (DLT) network associated with the digital assets 34 and includes transaction data 100. To mitigate potential errors and risk, upon obtaining digital asset-based interaction information and/or digital assets for a digital asset-based interaction, the digital asset-based interaction authorization module 82 performs an authorization process to authorize the digital asset-based interaction.

To authorize the digital asset-based interaction, the comparison module 88 compares system authorization parameters 94 with digital asset-based interaction characteristics 92 to produce a result 90 (e.g., authorized or not authorized). In this example, the system authorization parameter module 84 identifies digital asset DLT network information (info) 98 of a minimum fee value of 200 (e.g., by connecting to the digital asset DLT network to obtain fee information) as a system authorization parameter 94 for the incoming digital asset-based interaction.

The digital asset-based interaction characteristics module 86 identifies a fee value 140 of 100 from the transaction data 100 as a digital asset-based interaction characteristic 92. The comparison module 88 compares the system authorization parameter 94 and the digital asset-based interaction characteristic 92 to determine whether the fee is within a threshold of the minimum fee to determine whether the system authorization parameter 94 and the digital asset-based interaction characteristic 92 compare favorably. For example, the fee value must be equal to or higher than the minimum fee for a favorable comparison (e.g., as determined by a system threshold tolerance and/or industry standards). Additionally, the fee value may need to be within a certain percentage of the minimum fee value for a favorable comparison. For example, a fee that is too high may be indicative of an error.

In this example, the digital asset-based interaction characteristic 92 of the fee value 140 of 100 is not equal to or higher than the system authorization parameter 94 of the minimum fee value of 200. Therefore, the comparison module 88 produces a result 90 that the digital asset-based interaction is not authorized.

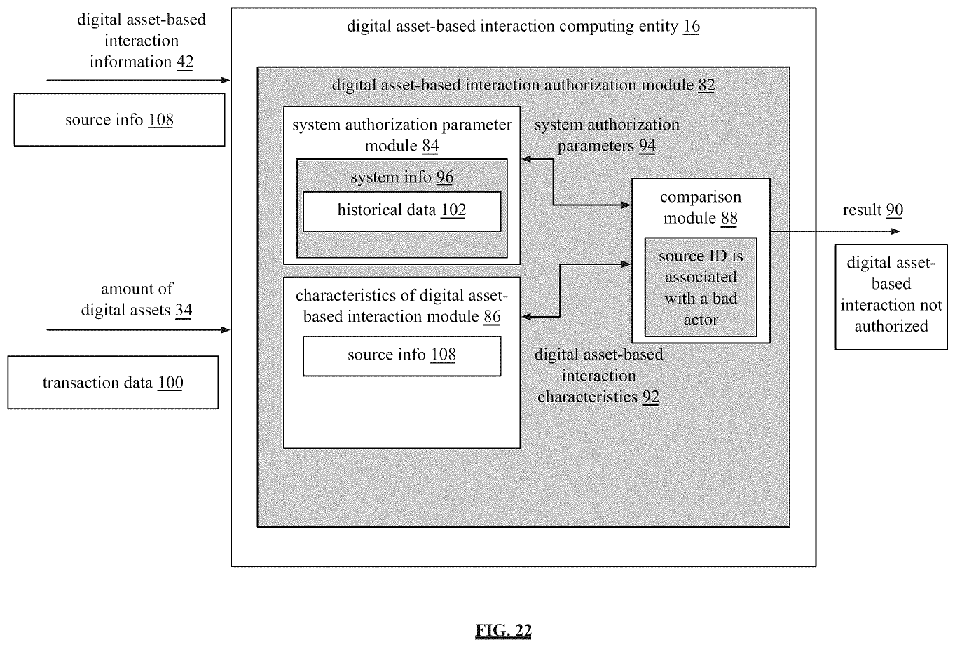

FIG. 22 is a schematic block diagram of an embodiment of a digital asset-based interaction computing entity 16 that includes a digital asset-based interaction authorization module 82. The digital asset-based interaction authorization module 82 includes a system authorization parameter module 84, a digital asset-based interaction characteristics module 86, and a comparison module 88.

In this example, a digital asset-based interaction has been initiated (e.g., the digital asset-based interaction computing entity 16 has obtained the digital asset-based interaction information 42) and the digital asset-based interaction computing entity 16 has obtained an amount of digital assets 34 from a source computing entity for the digital asset-based interaction. The amount of digital assets 34 received from the source computing entity is a transaction added to the digital asset distributed ledger technology (DLT) network associated with the digital assets 34 and includes transaction data 100. To mitigate potential errors and risk, upon obtaining digital asset-based interaction information and/or digital assets for a digital asset-based interaction, the digital asset-based interaction authorization module 82 performs an authorization process to authorize the digital asset-based interaction.

To authorize the digital asset-based interaction, the comparison module 88 compares system authorization parameters 94 with digital asset-based interaction characteristics 92 to produce a result 90 (e.g., authorized or not authorized). In this example, the system authorization parameter module 84 identifies system information (info) 96 of historical data 102 as a system authorization parameter 94 for an incoming digital asset-based interaction.

The digital asset-based interaction characteristics module 86 identifies source information (info) 108 (e.g., a source computing entity identifier (ID)) from the digital asset-based interaction information 42 as a digital asset-based interaction characteristic 92. The comparison module 88 compares the system authorization parameter 94 and the digital asset-based interaction characteristic 92 to determine whether the source ID from the source information 108 is associated with past bad behavior found in the historical data 102 (e.g., previously failed authorization attempts, suspicious behavior, fraudulent behavior, etc.).

In this example, the digital asset-based interaction characteristic 92 of the source information 108 is associated with the system authorization parameter 94 of bad actor information associated with the source information 108 found in the historical data 102. Therefore, the comparison module 88 produces a result 90 that the digital asset-based interaction is not authorized.

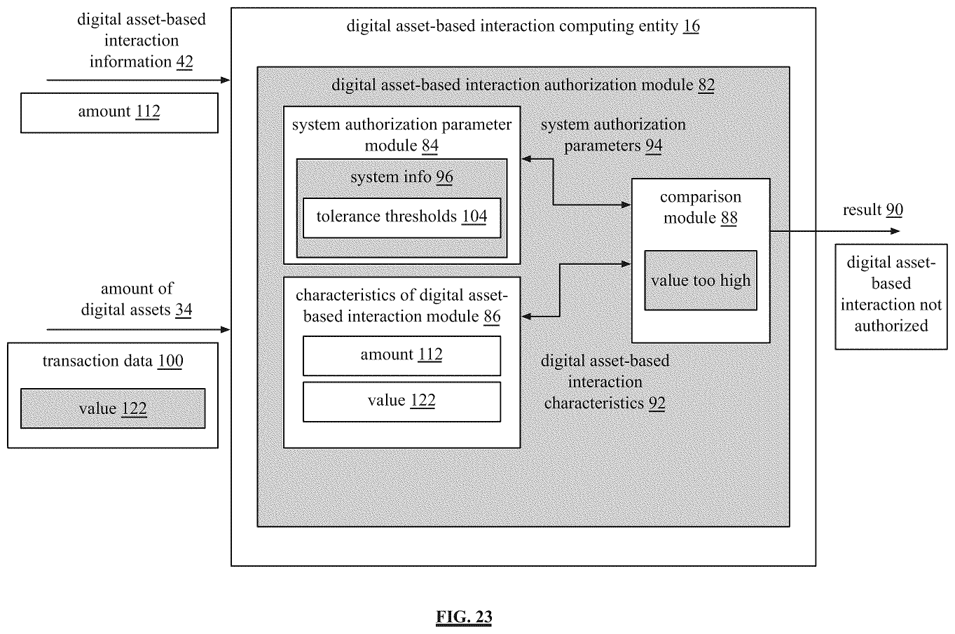

FIG. 23 is a schematic block diagram of an embodiment of a digital asset-based interaction computing entity 16 that includes a digital asset-based interaction authorization module 82. The digital asset-based interaction authorization module 82 includes a system authorization parameter module 84, a digital asset-based interaction characteristics module 86, and a comparison module 88.

In this example, a digital asset-based interaction has been initiated (e.g., the digital asset-based interaction computing entity 16 has obtained the digital asset-based interaction information 42) and the digital asset-based interaction computing entity 16 has obtained an amount of digital assets 34 from a source computing entity for the digital asset-based interaction. The amount of digital assets 34 received from the source computing entity is a transaction added to the digital asset distributed ledger technology (DLT) network associated with the digital assets 34 and includes transaction data 100. To mitigate potential errors and risk, upon obtaining digital asset-based interaction information and/or digital assets for a digital asset-based interaction, the digital asset-based interaction authorization module 82 performs an authorization process to authorize the digital asset-based interaction.

To authorize the digital asset-based interaction, the comparison module 88 compares system authorization parameters 94 with digital asset-based interaction characteristics 92 to produce a result 90 (e.g., authorized or not authorized). In this example, the system authorization parameter module 84 identifies system information (info) 96 of tolerance thresholds 104 (e.g., an amount threshold) as a system authorization parameter 94 for an incoming digital asset-based interaction (e.g., digital asset-based interaction information 42 including an amount 112 has been received and an amount of digital assets 34 has been received along with transaction data 100).

The digital asset-based interaction characteristics module 86 identifies the amount 112 from the digital asset-based interaction information 42 and the value 122 sent from the transaction data 100 as the digital asset-based interaction characteristics 92. The comparison module 88 compares the system authorization parameter 94 and the digital asset-based interaction characteristics 92 to determine whether the value 122 is with an amount threshold of the amount 112.

In this example, the digital asset-based interaction characteristics 92 of the amount 112 and the value 122 do not compare favorably with the system authorization parameter 94 (e.g., the system authorization parameter 94 may indicate the value 122 must with within 1% of the amount 112 owed). In this example, the value 122 sent is too high and likely indicative of an error. Therefore, the comparison module 88 produces a result 90 that the digital asset-based interaction is not authorized.

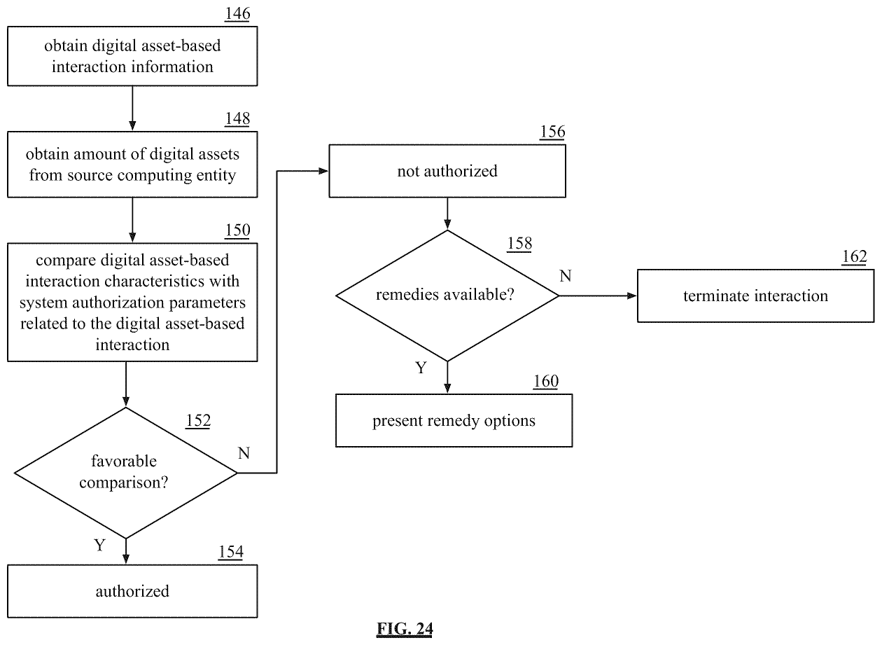

FIG. 24 is a flowchart of an example of a method of a digital asset-based interaction authorization process executable by a digital asset-based interaction authorization module of a digital asset-based interaction computing entity of a digital asset-based interaction system.

The method begins with step 146 where the digital asset-based interaction computing entity obtains digital asset-based interaction information from one or more of a source computing entity and a destination computing entity. The digital asset-based interaction involves the source computing entity providing digital assets and the second computing entity accepting desired assets. The digital asset-based interaction information includes source computing entity information (e.g., a source computing entity identifier (ID)), destination computing entity information (e.g., a destination computing entity identifier (ID)), item(s) involved in the digital asset-based interaction, the amount of the digital asset-based interaction, digital asset-based interaction metadata, etc.

The method continues with step 148 where the digital asset-based interaction computing entity obtains an amount of digital assets from the source computing entity. Obtaining the amount of the digital assets is a transaction added to a digital asset distributed ledger technology (DLT) network associated with the digital assets. The method continues with step 150 where the digital asset-based interaction authorization module of the digital asset-based interaction computing entity compares digital asset-based interaction characteristics with system authorization parameters related to the digital asset-based interaction.

The digital asset-based interaction characteristics include the digital asset-based interaction information (e.g., source computing entity information, destination computing entity information, item(s) involved in the digital asset-based interaction, the amount of the digital asset-based interaction, digital asset-based interaction metadata, etc.) and transaction data pertaining to the source computing entity sending digital assets to the digital asset-based interaction computing entity 16. The information contained in the transaction data depends on the type of digital asset and digital asset DLT network involved. For example, in an Ethereum transaction, transaction data includes the recipient (e.g., an address), a signature of the sender, a nonce, a value (e.g., the amount of the digital assets being sent), data, a gas limit, a max priority fee per gas, and a max fee per gas. The transaction data typically includes at least a signature (signed with a private key), an output (e.g., a destination for the funds), an amount (e.g., the amount involved in the transaction), and a transaction fee.

The system authorization parameters include system information and digital asset DLT network information. The system information includes historical data, user information, and/or system tolerance thresholds. The historical data may include past digital asset-based interaction information such as the information pertaining to the parties involved (e.g., source computing entity identifiers (IDs), destination computing entity identifiers (IDs), merchant information, etc.), digital asset-based interaction amounts, whether or not a digital asset-based interaction was successful, etc., as well as historical authorization information such as a list of users associated with unauthorized digital asset-based interactions and/or suspicious activity.

Suspicious activity could include errors (e.g., the amount of digital assets sent is less than or more than the amount owed for the digital asset-based interaction), transaction fee issues (e.g., a transaction fee is too low which could be an indication of potential fraud), repeated digital asset-based interaction terminations (e.g., the user has a history of initiating and canceling digital asset-based interactions), etc.

The system tolerance thresholds include ranges of tolerance to use in comparison situations. The system tolerance thresholds may be stored/generated as system information and provided to the comparison module to use in comparisons. For example, certain digital asset-based interaction characteristics may be compared with each other in accordance with a system tolerance threshold. For example, a system tolerance threshold for the amount of the digital asset-based interaction may be 0%. For example, if the source computing entity sends an amount of digital assets that is not exactly equal to the amount of the digital assets in the digital asset-based interaction as identified in the digital asset-based interaction information (e.g., it is too low or too high), the digital asset-based interaction may not be authorized.

User information includes identifying information of parties involved in past and/or current digital asset-based interactions as well as any personal information such as email address, username, password, physical address, loyalty information, etc. Historical user information may be stored with the historical data. In an example, a source computing entity may provide a username and password as identifying information while initiating a digital asset-based interaction. This username and password (e.g., digital asset-based interaction characteristics) will be cross referenced with username and password combinations stored in the user information (e.g., system authorization parameters) for errors and/or issues (e.g., the source computing entity may enter the wrong password associated with its source identifier (ID)).

The digital asset DLT network information includes any information of interest related to a particular digital asset DLT network. For example, the digital asset DLT network information may include price history of the digital assets, market capitalization, block information (e.g., when the digital asset DLT network is a blockchain), circulating supply of the digital assets, a maximum supply, the validation procedure used (e.g., a consensus algorithm such as proof of work or proof of stake), algorithms used, transaction data, validation procedure timing information (e.g., average confirmation time), mempool (e.g., a temporary storage area for transactions, a “memory pool”) information, transaction fees, validator rewards (e.g., a block reward), etc. The system authorization parameters may be generated based on a digital asset-based interaction to digital asset-based interaction basis and/or pre-generated.

The method continues with step 152 where the digital asset-based interaction authorization module determines whether the comparison is favorable. For example, a favorable comparison may occur when a transaction fee (e.g., a digital asset-based interaction characteristic) is greater than or equal to a minimum transaction fee value (e.g., a system authorization parameter). When the comparison is favorable, the method continues with step 154 where the digital asset-based interaction is authorized. When the comparison is not favorable, the method continues with step 156 where the digital asset-based interaction is not authorized. For example, an unfavorable comparison may occur when a transaction fee (e.g., a digital asset-based interaction characteristic) is lower than a minimum transaction fee value (e.g., a system authorization parameter).

When the digital asset-based interaction is not authorized at step 156, the method continues with step 158 where the digital asset-based interaction authorization module determines whether there are remedies available. For example, if the digital asset-based interaction was not authorized because the amount of digital assets sent was too high, the source computing entity may be given a chance to correct the amount. As another example, if the digital asset-based interaction was not authorized because the transaction fee for the amount of digital assets sent was too low, the source computing entity may be given a chance to increase the fee.

When there are remedies available at step 158, the method continues with step 160 where the digital asset-based interaction authorization module presents the remedy options to the source computing entity. For example, when the source computing entity scans a scannable code presented by the destination computing entity to forward the digital assets to the digital asset-based interaction computing entity and the digital asset-based interaction is not authorized, the digital asset-based interaction authorization module may send a notification to the destination computing entity that the digital asset-based interaction was not authorized and to have the source computing entity scan the code again (or scan a new code) to correct any errors or issues.

In another example, a remedy notification may be pushed directly to the source computing entity when scanning the code establishes a communication between the source computing entity and the digital asset-based interaction computing entity or when the source computing entity accesses the destination computing entity via an application installed on the source computing entity.

When the are no remedies available at step 158, the method continues with step 162 where the digital asset-based interaction authorization module terminates the digital asset-based interaction. For example, when the digital asset-based interaction authorization module identifies the source computing entity as a previously bad actor, there may be no remedies available, and the digital asset-based interaction may be terminated. When the digital asset-based interaction is terminated, the digital asset-based interaction authorization module may send a termination notification to one or more of the source computing entity and the destination computing entity.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining -A matches -B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e., machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
obtaining, by a digital asset-based interaction computing entity of a digital asset-based interaction system, digital asset-based interaction information from one or more of a source computing entity and a destination computing entity of the digital asset-based interaction system, wherein the digital asset-based interaction information is regarding a digital asset-based interaction between the source computing entity and the destination computing entity, wherein the digital asset-based interaction involves the source computing entity providing a first amount of digital assets and the destination computing entity accepting a second amount of desired assets, and wherein the destination computing entity is associated with the digital asset-based interaction computing entity via a digital asset-based interaction interface;
performing, by the digital asset-based interaction computing entity, a real-time digital asset-based interaction process to facilitate the digital asset-based interaction between the source computing entity and the destination computing entity in real-time; and
performing, by the digital asset-based interaction computing entity, a nonreal-time digital asset-based interaction process to reconcile the real-time digital asset-based interaction process with a digital asset backing computing entity of the digital asset-based interaction system, wherein the digital asset backing computing entity is associated with a transformer pool of the digital asset-based interaction system, wherein the transformer pool is associated with at least one consensus network computing entity node of a digital asset distributed ledger technology (DLT) network associated with the digital assets, and wherein the transformer pool stores system digital assets to back digital asset-based interactions involving the digital assets.

2. The method of claim 1, wherein the digital asset-based interaction information includes a source computing entity identifier (ID), a type of the digital assets, a type of the desired assets, and a destination computing entity identifier (ID).

3. The method of claim 2, wherein the digital asset-based interaction information further includes one or more of:
an amount of the digital asset-based interaction; and
an item involved in the digital asset-based interaction.

4. The method of claim 1, wherein the performing the real-time digital asset-based interaction process comprises:
obtaining, by the digital asset-based interaction computing entity, the first amount of the digital assets from the source computing entity;
authorizing, by the digital asset-based interaction computing entity, the digital asset-based interaction in accordance with system authorization parameters; and
when the digital asset-based interaction is authorized:
exchanging, by the digital asset-based interaction computing entity, the first amount of the digital assets to the second amount of the desired assets, wherein the first amount is substantially equal to the second amount; and
providing, by the digital asset-based interaction computing entity, the second amount of the desired assets to the destination computing entity.

5. The method of claim 1, wherein the performing the nonreal-time digital asset-based interaction process comprises:
instructing, by the digital asset-based interaction computing entity, the digital asset backing computing entity to lock an amount of the system digital assets within the transformer pool to back the digital asset-based interaction;
connecting, by the digital asset-based interaction computing entity, to the digital asset DLT network associated with the digital assets, wherein the digital asset DLT network implements a validation procedure to verify the first amount of the digital assets sent by the source computing entity; and
obtaining, by the digital asset-based interaction computing entity, results of the validation procedure from the digital asset DLT network.

6. The method of claim 5 further comprises:
when the results indicate that the first amount of the digital assets are verified:
instructing, by the digital asset-based interaction computing entity, the digital asset backing computing entity to release the amount of the system digital assets; and
when the results indicate that the first amount of the digital assets are not verified:
instructing, by the digital asset-based interaction computing entity, the digital asset backing computing entity to consume the amount of the system digital assets.

7. The method of claim 6, wherein the instructing the digital asset backing computing entity to consume the amount of the system digital assets comprises:
instructing, by the digital asset-based interaction computing entity, the digital asset backing computing entity to transfer the amount of the system digital assets from an address associated with the transformer pool to an address associated with the digital asset-based interaction computing entity.

8. The method of claim 1, wherein the source computing entity is associated with the digital asset-based interaction computing entity via a source computing entity digital asset-based interaction interface.

9. The method of claim 1, wherein the digital asset backing computing entity is associated with a second transformer pool of the digital asset-based interaction system, wherein the second transformer pool is associated with a second digital asset DLT network associated with second digital assets, and wherein the second transformer pool stores second system digital assets to back digital asset-based interactions involving the second digital assets.

10. A digital asset-based interaction system comprises:
a source computing entity including an asset management unit, wherein the asset management unit is operable to store digital assets;
a destination computing entity including a digital asset-based interaction interface associated with a digital asset-based interaction computing entity;
a digital asset backing computing entity operable to manage system digital assets, wherein the system digital assets are used to back digital asset-based interactions;
wherein the digital asset-based interaction computing entity is operable to:
obtain digital asset-based interaction information from one or more of the source computing entity and the destination computing entity, wherein the digital asset-based interaction information is regarding a digital asset-based interaction between the source computing entity and the destination computing entity, wherein the digital asset-based interaction involves the source computing entity providing a first amount of the digital assets and the destination computing entity accepting a second amount of desired assets;
perform a real-time digital asset-based interaction process to facilitate the digital asset-based interaction between the source computing entity and the destination computing entity in real-time; and
perform a nonreal-time digital asset-based interaction process to reconcile the real-time digital asset-based interaction process with the digital asset backing computing entity; and
one or more transformer pools associated with the digital asset backing computing entity, wherein the one or more transformer pools are associated with one or more consensus network computing entity nodes of one or more digital asset distributed ledger technology (DLT) networks, wherein a digital asset DLT network of the one or more digital asset DLT networks is associated with the digital assets, wherein the one or more transformer pools are operable to store the system digital assets for backing digital asset-based interactions, and wherein a transformer pool of the one or more transformer pools stores a portion of the system digital assets for backing digital asset-based interactions involving the digital assets.

11. The digital asset-based interaction system of claim 10, wherein the digital asset-based interaction information includes a source computing entity identifier (ID), a type of the digital assets, a type of the desired assets, and a destination computing entity identifier (ID).

12. The digital asset-based interaction system of claim 11, wherein the digital asset-based interaction information further includes one or more of:
an amount of the digital asset-based interaction; and
an item involved in the digital asset-based interaction.

13. The digital asset-based interaction system of claim 10, wherein the digital asset-based interaction computing entity is operable to perform the real-time digital asset-based interaction process by:
obtaining the first amount of the digital assets from the source computing entity;
authorizing the digital asset-based interaction in accordance with system authorization parameters; and
when the digital asset-based interaction is authorized:
exchanging the first amount of the digital assets to the second amount of the desired assets,
wherein the first amount is substantially equal to the second amount; and
providing the second amount of the desired assets to the destination computing entity.

14. The digital asset-based interaction system of claim 10, wherein the digital asset-based interaction computing entity is operable to perform the nonreal-time digital asset-based interaction process by:
instructing the digital asset backing computing entity to lock an amount of the portion of the system digital assets within the transformer pool to back the digital asset-based interaction;
connecting to the digital asset DLT network associated with the digital assets, wherein the digital asset DLT network implements a validation procedure to verify the first amount of the digital assets sent by the source computing entity; and
obtaining results of the validation procedure from the digital asset DLT network.

15. The digital asset-based interaction system of claim 14, wherein the digital asset-based interaction computing entity is further operable to:
when the results indicate that the first amount of the digital assets are verified, the digital asset-based interaction computing entity is further operable to:
instruct the digital asset backing computing entity to release the amount of the portion of the system digital assets; and
when the results indicate that the first amount of the digital assets are not verified, the digital asset-based interaction computing entity is further operable to:
instruct the digital asset backing computing entity to consume the amount of the portion of the system digital assets.

16. The digital asset-based interaction system of claim 15, wherein the digital asset-based interaction computing entity is operable to instruct the digital asset backing computing entity to consume the amount of the system digital assets by:
instructing the digital asset backing computing entity to transfer the amount of the portion of the system digital assets from an address associated with the transformer pool to an address associated with the digital asset-based interaction computing entity.

17. The digital asset-based interaction system of claim 10 further comprises:
one or more staking computing entities operable to provide the system digital assets.

18. A digital asset-based interaction computing entity of a digital asset-based interaction system, the digital asset-based interaction computing entity comprises:
memory;
an interface; and
a processing module operably coupled to the memory and the interface, wherein the processing module is operable to:
obtain digital asset-based interaction information from one or more of source computing entity and a destination computing entity of the digital asset-based interaction system, wherein the digital asset-based interaction information is regarding a digital asset-based interaction between the source computing entity and the destination computing entity, wherein the digital asset-based interaction involves the source computing entity providing a first amount of digital assets and the destination computing entity accepting a second amount of desired assets, and wherein the destination computing entity is associated with the digital asset-based interaction computing entity via a digital asset-based interaction interface;
perform a real-time digital asset-based interaction process to facilitate the digital asset-based interaction between the source computing entity and the destination computing entity in real-time; and
perform a nonreal-time digital asset-based interaction process to reconcile the real-time digital asset-based interaction process with a digital asset backing computing entity of the digital asset-based interaction system, wherein the digital asset backing computing entity is associated with a transformer pool of the digital asset-based interaction system, wherein the transformer pool is associated with one or more consensus network computing entity nodes of a digital asset distributed ledger technology (DLT) network associated with the digital assets, and wherein the transformer pool stores system digital assets to back digital asset-based interactions involving the digital assets.

19. The digital asset-based interaction computing entity of claim 18, wherein the digital asset-based interaction information includes a source computing entity identifier (ID), a type of the digital assets, a type of the desired assets, and a destination computing entity identifier (ID).

20. The digital asset-based interaction computing entity of claim 19, wherein the digital asset-based interaction information further includes one or more of:
an amount of the digital asset-based interaction; and
an item involved in the digital asset-based interaction.

21. The digital asset-based interaction computing entity of claim 18, wherein the processing module is operable to perform the real-time digital asset-based interaction process by:
obtaining the first amount of the digital assets from the source computing entity;
authorizing the digital asset-based interaction in accordance with system authorization parameters; and
when the digital asset-based interaction is authorized:
exchanging the first amount of the digital assets to the second amount of the desired assets,
wherein the first amount is substantially equal to the second amount; and
providing the second amount of the desired assets to the destination computing entity.

22. The digital asset-based interaction computing entity of claim 18, wherein the processing module is operable to perform the nonreal-time digital asset-based interaction process by:
instructing the digital asset backing computing entity to lock an amount of the system digital assets within the transformer pool to back the digital asset-based interaction;
connecting to the digital asset DLT network associated with the digital assets, wherein the digital asset DLT network implements a validation procedure to verify the first amount of the digital assets sent by the source computing entity; and
obtaining results of the validation procedure from the digital asset DLT network.

23. The digital asset-based interaction computing entity of claim 22, wherein the processing module is further operable to:
when the results indicate that the first amount of the digital assets are verified:
instruct the digital asset backing computing entity to release the amount of the system digital assets; and
when the results indicate that the first amount of the digital assets are not verified:
instruct the digital asset backing computing entity to consume the amount of the system digital assets.

24. The digital asset-based interaction computing entity of claim 23, wherein the processing module is operable to instruct the digital asset backing computing entity to consume the amount of the system digital assets by:
instructing the digital asset backing computing entity to transfer the amount of the system digital assets from an address associated with the transformer pool to an address associated with the digital asset-based interaction computing entity.

25. The digital asset-based interaction computing entity of claim 18, wherein the source computing entity is associated with the digital asset-based interaction computing entity via a source computing entity digital asset-based interaction interface.
